(19) United States
(12) Patent Application Publication
(10) Pub. No.: US 2026/0184213 A1
(43) Pub. Date: Jul. 2, 2026

(54) METHOD OF ADJUSTING SUBSEQUENT SCHEDULE AFTER AN OCCURRENCE OF A FAULT

(71) Applicant: Volvo Car Corporation, Göteborg (SE)

(72) Inventors: Adina-Maria Sorostinean, Gothenburg (SE); Madhan Kumar Balasubramani, Gothenburg (SE); Meng Liu, Gothenburg (SE); Sayali Kheratkar, Gothenburg (SE); Megha Bennur, Gothenburg (SE); Karthikeyan Ravindran, Gothenburg (SE)

(21) Appl. No.: 19/006,683

(22) Filed: Dec. 31, 2024

(51) Int. Cl. B60L 53/60; G06F 11/07; G06Q 50/06

(52) U.S. Cl. CPC B60L 53/60; G06Q 50/06

(57) ABSTRACT

Various systems and methods are presented regarding a battery charging operation being conducted at a battery charging center, for addressing occurrence of a fault. For example, a charging station can comprise a memory that stores computer executable components, and a processor that executes the computer executable components stored in the memory, wherein the computer executable components comprise a notification component notifies an owner of a current charging session that an adjustment to the charging session is required due to an occurrence of a fault, a dynamic schedule adjustment component generates one or more adjusted charging session scenarios, and a communication component that transmits a confirmation message to the owner of the current charging session, wherein the request message comprises parameters for one or more adjusted charging scenarios.

### TECHNICAL FIELD

This application relates to a battery charging system and addressing impact on subsequent schedules after an occurrence of a charging fault.

### BACKGROUND

During charging of an electric vehicle, it is possible for a charging fault to occur during the charging process. Conventionally, the charging system does not automatically restart once the fault is cleared, external interaction is required to restart/reset the system, such as an entity confirming the fault has been ascertained, cleared, and charging can resume. Upon the occurrence of a fault and reset, the system would need to make adjustments to the current charing schedule to insure proper user experience. In addition, the adjustments may impact one or more subsequent scheduled user and thereby requiring notification of a possible change in charging scheme or amount of time allocated for charging for the subsequent scheduled users.

The above-described background is merely intended to provide a contextual overview of some current issues and is not intended to be exhaustive. Other contextual information may become further apparent upon review of the following detailed description.

### SUMMARY

The following presents a summary to provide a basic understanding of one or more embodiments described herein. This summary is not intended to identify key or critical elements or delineate any scope of the different embodiments and/or any scope of the claims. The sole purpose of the summary is to present some concepts in a simplified form as a prelude to the more detailed description presented herein.

In one or more embodiments described herein, systems, devices, computer-implemented methods, methods, apparatus, and/or computer program products are presented to facilitate addressing a fault condition, notifying the owner that fault had occurred which now requires a manual reset, and seeking assistance from connected cars and others in the area. According to one or more embodiments, a system can comprise at least one processor and at least one memory coupled to at least one processor and having instructions stored thereon. In response to the at least one processor executing the instructions, the instructions facilitate performance of operations, comprising: a notification component notifies an owner of a current charging session that an adjustment to the charging session requires due to an occurrence of a fault. The operations further comprise a dynamic schedule adjustment component generates one or more adjusted charging session scenarios, and a communication component that transmits a confirmation message to the owner of the current charging session, wherein the request message comprises parameters for one or more adjusted charging scenarios.

According to another embodiment, a method can comprise alerting, by a system of the charging stations comprising one or more components, an owner of a current charging session that an adjustment to the charging session is required due to an occurrence of a fault. The method further comprises generating, by the system, one or more adjusted charging session scenarios, and transmitting, by the system, a confirmation message to the owner of the current charging session, wherein the request message comprises parameters for the one or more adjusted charging scenarios.

According to yet another embodiment, a non-transitory machine-readable medium can comprise executable instructions that, when executed by a processor of a vehicle system, facilitate performance of operations, comprising alerting an owner of a current charging session that an adjustment to the charging session is required due to an occurrence of a fault, generating one or more adjusted charging session scenarios, and transmitting a confirmation message to the owner of the current charging session, wherein the request message comprises parameters for the one or more adjusted charging scenarios.

An advantage of the one or more systems, computer-implemented methods, and/or computer program products can be utilizing various systems and technologies to (a) detect fault, resolve the fault, and seek assistance to manually reset the fault to resume charging in the event the charging cannot be restarted remotely.

### DESCRIPTION OF THE DRAWINGS

One or more embodiments are described below in the Detailed Description section with reference to the following drawings.

FIGS. 1A-1C illustrate a system comprising various components and devices configured to control a battery charging operation, in accordance with at least one embodiment.

FIG. 2 presents a schematic of an example fault screen, in accordance with one or more embodiments presented herein, in accordance with an embodiment.

FIG. 3 presents a schematic of an example schedule screen, in accordance with one or more embodiments presented herein.

FIG. 4 presents a flowchart of an example computer-implemented method for scheduling a battery charging operation, in accordance with an embodiment.

FIG. 5 presents a flowchart of an example computer-implemented method for scheduling a battery charging operation, in accordance with an embodiment.

FIG. 6 presents a flowchart of an example computer-implemented method for scheduling a battery charging operation, in accordance with an embodiment.

FIG. 7 presents a flowchart of a computer-implemented method for resetting a fault condition of a battery charging operation, in accordance with an embodiment.

FIG. 8 presents a flowchart of a computer-implemented method for resetting a fault condition of a battery charging operation, in accordance with an embodiment.

FIG. 9 presents a flowchart of a computer-implemented method for resetting a fault condition of a battery charging operation, in accordance with an embodiment.

FIG. 10 illustrates a block diagram of an exemplary system that facilitates addressing a fault condition, in accordance with one or more embodiments described herein.

FIG. 11 illustrates a block flow diagram of another example non-limiting computer-implemented method to facilitate addressing a fault condition, in accordance with one or more embodiments described herein.

FIG. 12 illustrates a block flow diagram of another example, non-limiting computer-implemented method to facilitate addressing a fault condition, in accordance with one or more embodiments described herein.

FIG. 13 illustrates a block flow diagram of another example, non-limiting computer-implemented method to facilitate addressing a fault condition, in accordance with one or more embodiments described herein.

FIG. 14 illustrates a block flow diagram of another example non-limiting computer-implemented method to facilitate addressing a fault condition, in accordance with one or more embodiments described herein.

FIG. 15 is a block diagram illustrating an example computing environment in which the various embodiments described herein can be implemented.

FIG. 16 is a block diagram illustrating an example computing environment with which the disclosed subject matter can interact, in accordance with an embodiment.

### DETAILED DESCRIPTION

The following detailed description is merely illustrative and is not intended to limit embodiments and/or application or uses of embodiments. Furthermore, there is no intention to be bound by any expressed and/or implied information presented in any of the preceding Background section, Summary section, in the Detailed Description section, and/or the Abstract.

One or more embodiments are now described with reference to the drawings, wherein like referenced numerals are used to refer to like elements throughout. In the following description, for purposes of explanation, numerous specific details are set forth in order to provide a more thorough understanding of the one or more embodiments. It is evident, however, in various cases, that the one or more embodiments can be practiced without these specific details.

As used herein, “data” can comprise metadata. Further, ranges A-n are utilized herein to indicate a respective plurality of devices, components, signals etc., where n is any positive integer.

In the various embodiments presented herein, the disclosed subject matter can be directed to resuming a battery charging operation after occurrence of a charging fault, and further scheduling/rescheduling a battery charging operation, e.g., in an event of a current, or scheduled, charging operation requires more time to complete than was originally scheduled, e.g., due to a charging fault causing/introducing a delay into the charging operation.

When a charging fault occurs, the fault may not be reset expeditiously, causing a potential delay in the time required to complete the charging operation, which can lead to frustrating customer experience as the lost charging time can impact the time to complete the recharging operation, particularly where the customer's available time/schedule is limited.

For example, a first entity (e.g., owner, driver, vehicle operator, and suchlike, operating a first electric vehicle (EV)) may have scheduled a first charging operation to last for 2 hours, from noon til 2:00 PM. However, after the initial 30 minutes of charging, a charge fault occurs and is not reset for another 30 minutes, causing the first charging schedule to now be 30 minutes in arrears, and now expected to not be completed until 2:30 PM. Accordingly, the first entity can endure the inconvenience of the additional charge time, however, the time over-run could negatively affect an agenda of a second entity (e.g., second driver operating a second EV) scheduled for a second charge at 2:00 PM at the same battery charging system.

In an embodiment, the charging system can be configured, if possible, to implement a fast charge to complete the first charging operation by 2:00 PM. However, even with a fast charge implemented, there still may be insufficient time to complete the first charging operation in a timely manner. In a first example scenario, the first EV undergoes a partial charge and an additional charging schedule is provided at a subsequent time (e.g., later in the day, the next available day, and suchlike) to faciliate a complete recharge of the battery (e.g., battery module, battery pack) on the first vehicle. In another example scenario, the first charging operation of the first EV has to be conducted/completed as the current charge of the battery on the first EV is insufficient for the first entity to complete a journey they are currently engaged with or are about to/soon to conduct. Hence, the charging operation of the first EV is performed until completed, even with the additional delay to the first driver, whereby the recharging of the battery on the second EV is rescheduled for another time, at another battery charging system, and scuhlike. In an embodiment, the second entity can be incentivized to undertake the postponed charging of the second EV, e.g., via monetary compensation, a redeemable coupon, and suchlike.

An EV can include an onboard battery pack comprising a group/set of battery cells. A battery pack/onboard battery can comprise any medium/device for storing/discharging electrical energy. A battery pack can comprise of any of a single battery cell, a battery pack comprising a group/set/collection of battery cells electrically connected/coupled together, a battery pack comprising two or more battery modules electrically coupled wherein a battery module is formed from one or more battery cells, and suchlike. The terms battery, battery cell, battery pack, battery module, and suchlike, are used interchangeably herein. As further described, a battery pack can be a standalone device, such as a portable battery which can be readily connected/disconnected from a device for which the battery pack is to provide power, through to a battery pack that is located onboard a system (e.g., an EV), wherein the battery pack can provide electrical energy to the system, and also receive electrical energy from the system.

The various embodiments presented herein can be utilized to control discharging of any battery, wherein the battery may be located on a vehicle, military vehicle, railroad vehicle, a marine vehicle such as a boat, ship, submarine, or marine drone, a winged vehicle such as a plane or drone, a rotor-ed vehicle such as a helicopter or drone, and the like. Likewise, one or more embodiments presented herein can be extended to controlling charging of a battery located on a robot and/or any suitable moving or stationary device. Other applicable applications include scooters, Segway®, electric bicycles, E-rickshaws, and the like. Further, one or more embodiments presented herein can be utilized to control charging of a battery, wherein the battery is a standalone device, e.g., the battery is not located on a vehicle, device, etc.

Further, the embodiments can be applied to any vehicle utilizing a battery discharging system, e.g., a Battery Electric Vehicle (BEV) where the powerplant is only an electric motor powered by a battery and the battery is recharged via an external charging station, a Hybrid Electric Vehicle (HEV) having both a gasoline/petrol engine & fuel tank and an electric motor powered by a battery, wherein operation of the HEV recharges the battery (e.g., via a regenerative braking system capturing kinetic energy), a Plug-in Hybrid Electric Vehicle (PHEV) having both a gasoline/petrol engine & fuel tank and an electric motor powered by a battery, wherein the battery can be charged via an external charging station, and the like.

It is to be appreciated that while the various embodiments and concepts are presented as directed to lithium-ion battery technologies, the various embodiments and concepts can be equally applied to any battery technology, including battery cells comprising lithium-ion (Li-ion), lithium nickel cobalt Aluminum (NCA), lithium-nickel manganese cobalt (NMC), lithium-manganese Spinel (LMO), lithium Titanate (LTO), lithium-iron Phosphate (LFP), lithium metal polymer (LMP), nickel manganese cobalt (NMC), nickel-metal hydride (Ni-MH), lithium sulphur (Li-S), lead-acid batteries, as well as ultracapacitors, super capacitors, chemical batteries, solid-state batteries, fuel cells, etc.

### Battery Charge Scheduling System

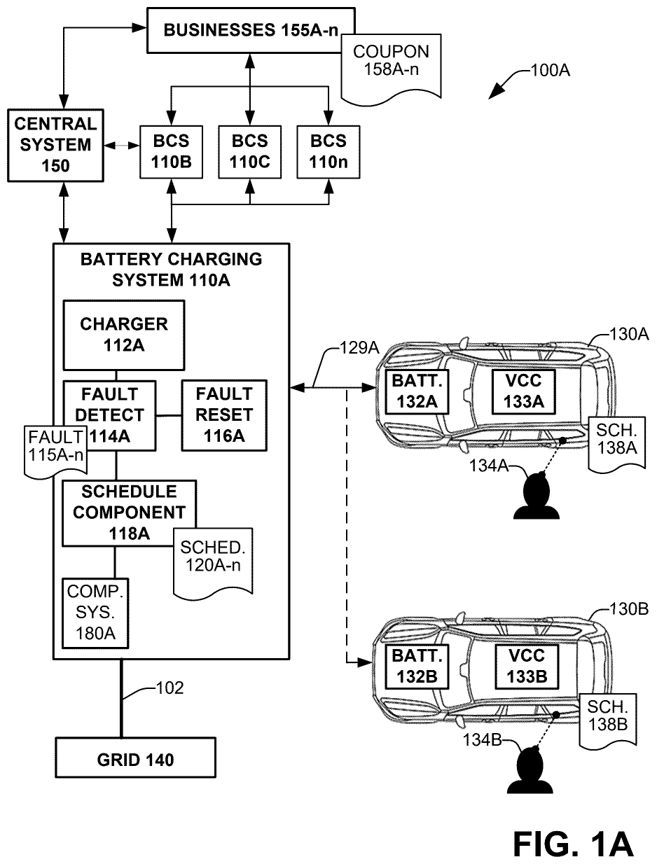

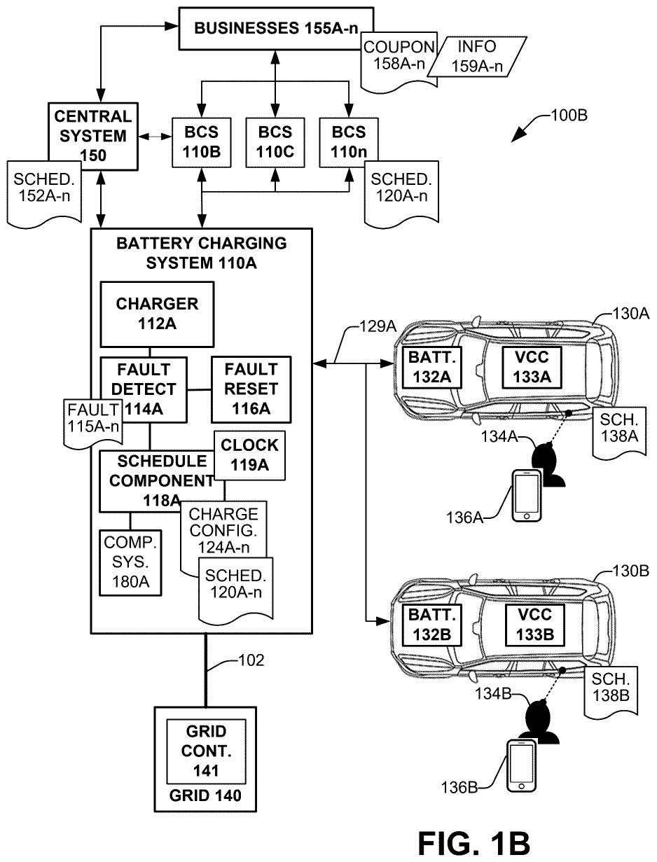

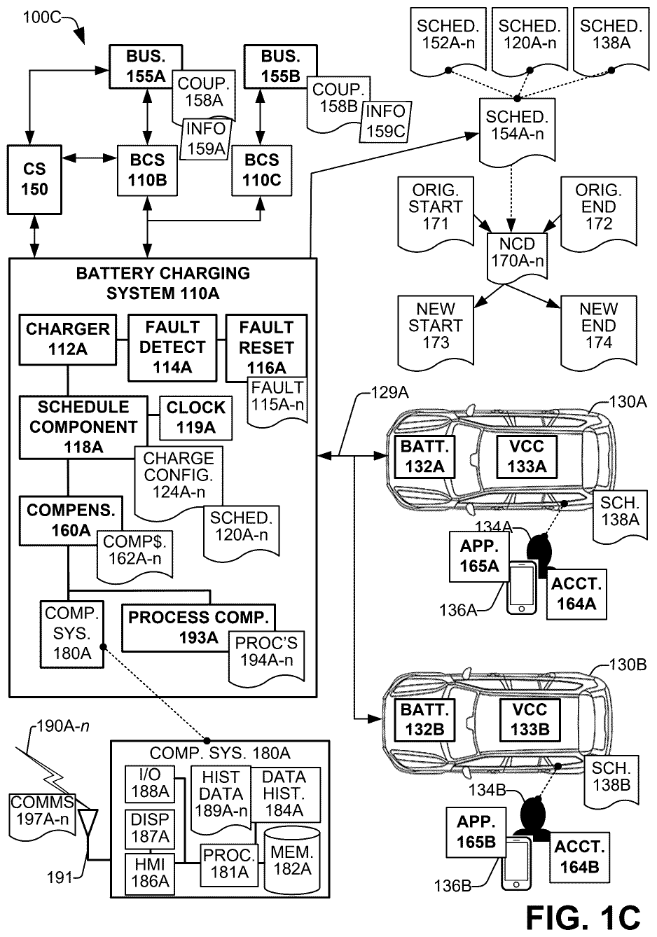

Turning now to the drawings, FIGS. 1A-1C present various illustrations of a system 100 (respectively systems 100A, 100B, 100C) comprising various components and devices configured to charge a battery, in accordance with one or more embodiments.

FIG. 1A presents a high-level overview 100A of system 100, comprising various components and devices configured to charge a battery, in accordance with at least one embodiment. System 100 comprises a group of battery charging systems (BCSs) 110A-n respectively configured to provision charging of a battery 132A-n respectively located onboard a vehicle 130A-n, whereby, battery 132A-n can be configured to provide electrical power/energy to one or more systems (e.g., propulsion, infotainment, navigation, climate control, and suchlike) located/operating onboard vehicle 130A-n. As shown, a first battery 132A located onboard a first vehicle 130A is undergoing charging at BCS 110A, in accordance with a first charging schedule 138A. A second vehicle 130B is scheduled to be charged, per schedule 138B, where schedule 138B is subsequent to schedule 138A, and can be negatively impacted by schedule 138A (e.g., schedule 138A is not completed within a scheduled time). Charging is performed at BCS 110A utilizing a charger 112A, a charging fault detection component 114A, and a schedule component 118A. As further described, schedule component 118A can operate in accordance with schedules 120A-n/138A-n. The fault detection component 114A can be configured to detect a fault 115A-n, whereby a fault reset component 116A can be configured to reset fault 115A-n. In the event of charging of vehicle 130B/battery 132B is conducted at another BCS 110B-n, information regarding businesses 155A-n (e.g., restaurants, museums, etc.) which are local to the respective business 155A-n can be identified, and incentives (e.g., vouchers, coupons 158A-n, and the like) can be offered, e.g., enabling an owner 134B of vehicle 130B to engage in an activity while waiting for battery 132B on vehicle 130B to be charged.

As further described, any components included in system 100 (e.g., BCS's 110A-n, central system 150, grid 140, and such), can include/be communicatively coupled to a computer system 180A-n (e.g., computer system 180A/180B/180C).

FIG. 1B, system 100B, further expands on the various components and devices in system 100 configured to charge a battery, in accordance with at least one embodiment. As mentioned, system 100 comprises a group of BCSs 110A-n respectively configured to provision charging of a battery 132A-n respectively located onboard a vehicle 130A-n. Battery 132A-n can comprise any medium/device for storing/discharging energy. In a non-limiting list of examples, battery 132A-n can comprise of any of a single battery cell, a battery pack comprising a group/set/collection of battery cells/battery modules electrically connected/coupled together, and suchlike, to facilitate provision of electrical energy to a system, device, equipment, and suchlike (e.g., from BCS 110A-n to battery 132A-n).

A vehicle 130A-n can have an associated entity 134A-n (e.g., an owner, operator, driver, and suchlike), whereby an entity 134A-n can utilize/operate/convey a respective computing device 136A-n communicatively coupled to one or more BCS's 110A-n. A device 136A-n can be a mobile computing device (e.g., a cellphone, a laptop computer, a portable computer, and suchlike) or a static device such as an infotainment system located onboard vehicle 130A-n. A charging schedule 138A-n can be associated with each vehicle 130A-n, wherein, as further described, a charging schedule 138A-n can be utilized to determine when battery 132A-n is to undergo charging at a BCS 110A-n.

In an example scenario, a first entity 134A can be an owner of a first vehicle, wherein battery 132A/vehicle 130A is to be charged at BCS 110A according to a first schedule 138A, whereby the first schedule 138A can be presented, and updated, via device 136A, wherein device 136A is communicatively coupled to BCS 110A. Further, a second entity 134B can be an owner of a second vehicle, battery 132B/vehicle 130B is to be charged at BCS 110A according to a second schedule 138B, whereby the second schedule 138B can be presented, and updated, via device 136B, wherein device 136B is communicatively coupled to BCS 110A.

As shown, BCS 110A can include a battery charger 112 connected to grid system 140, whereby the battery charger 112 can be configured to charge respective battery 132A-n with electrical energy provided by grid system 140. Connection between a battery 132A-n/vehicle 130A-n and a BCS 110A-n can utilize any required technique/technology, electrical connection, wiring, communication, and suchlike (e.g., in accordance with the respective standard/specification/regulation/grid code implemented between a grid system 140 and a BCS 110A-n). For example, in the event that the battery 132A-n is located onboard a vehicle 130A-n, connection between vehicle 130A-n/battery 132A-n and BCS 110A-n can be via a charging cable 129A-n, with cable 129A-n connected to the vehicle 130A-n via a plug (e.g., J1772, Combined Charging System (CCS), SAE Combo, Charge de Move (CHAdeMO), TESLA®), and suchlike, not shown) located at an end of cable 129A-n. Charging of a battery 132A-n can be controlled by BCS 110A-n (e.g., per a charger 112/a fault detection component 114/a schedule component 118) in conjunction with a vehicle control computer VCC 133A-n (e.g., a battery management system respectively located onboard vehicle 130A-n). VCC 133A-n can be configured to operate in conjunction with a local computer system with various commands, instructions, data, etc., being communicated (in communications 197A-n) between VCC 133A and BCS 110A.

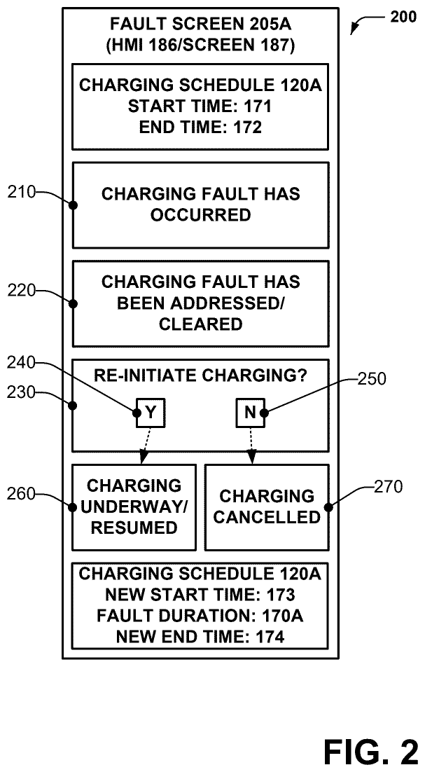

Grid system 140 can be any energy store/energy provider, such as a microgrid, a large-scale grid, e.g., a wide area synchronous grid, whereby a large-scale grid serves a region greater than microgrid, and suchlike. Grid system 140 can interact with BCS 110A-n via a grid controller 141 and charger 112A. For example, grid system 140 being in a fault condition can be reported by the grid controller 141 (e.g., in a communication 197X to a fault detection component 114A, and further presented on a fault screen 200, per FIG. 2) and further, the fault condition being cleared can also be reported by the grid controller 141 (e.g., in a communication 197Y to the fault detection component 114A, and further presented on a fault screen 200, per FIG. 2), whereupon fault detection component 114A can generate a fault cleared notification (e.g., presented on a fault screen 200, per FIG. 2).

As mentioned, BCS 110A can also include a fault detection component 114A configured to control operation of the charger 112A. For example, fault detection component 114A can be configured to detect an operational fault 115A-n with any of BCS 110A, grid 140, battery 132A-n, and suchlike, with regard to charging of battery 132A-n with energy received from grid 140. Causes of a charging fault are myriad, and in a non-limiting list, can include: grid 140 is experiencing a grid emergency condition, an energy “spike” occurred that could cause damage to battery 132A-n, grid 140, BCS 110A, etc. In response to detecting an occurrence of a fault 115A-n, charging of respective battery 132A-n by BCS 110A can be terminated (e.g., temporarily) by the fault detection component 114A.

BCS 110A can further include a fault reset component 116A, whereby fault reset component 116A can comprise of any suitable technology/structure to reset fault 115A-n, wherein suitable technology/structure can be a physical button (e.g., physically activated at BCS 110A, such as on a fault screen 205A, FIG. 2) and/or a digital reset which can be activated by a software application (e.g., application 165A-n, per FIG. 1C, on a fault screen 205A, FIG. 2) installed/operating on device 136A-n associated with vehicle 130A experiencing the charging fault 115A-n.

In an aspect, with the fault reset component 116 being activated, a fault 115A-n is acknowledged/reset, and charging of battery 132A-n by BCS 110 can be continued/recommenced. Upon the occurrence of a fault 115A-n being detected by fault detection component 114, the fault detection component 114 can be further configured to generate a fault notification (e.g., in communications 197A-n), wherein the fault notification can be transmitted across system 100 indicating to an entity 134A-n that BCS 110A is in a fault condition, and no charging of battery 132A-n is currently being performed at BCS 110A. In response to receiving the notification 197N of fault 115A-n (e.g., received via device 136A-n), an entity 134A-n proximate to BCS 110A-n can confirm the fault condition 115A-n has been addressed and utilize the fault reset 116A to reset BCS 110A to a no-fault condition, to enable charging of battery 132A to be resumed. In an alternative example, in response to receiving the notification 197N of fault condition 115A, entity 134A-n can utilize a fault reset button (e.g., presented by an application 165A-n on device 136A-n) to remotely reset the fault condition 115A-n, enabling charging of battery 132A to be resumed. In an aspect, the notification 197N of fault 115A-n can comprise two respective notifications, a first notification 197N can be transmitted in response to a determination by fault detection component 114A that a fault 115A has been detected (e.g., reported by grid controller 141 or occurring locally at BCS 110A), whereby the first notification 197N can indicate to an entity 134A-n that a fault 115A is present at BCS 110A-n. A second notification 197C of fault 115A-n can be transmitted to indicate that the fault 115A has been cleared (e.g., grid 140 is no longer experiencing a grid emergency), whereupon, entity 134A-n can remotely reset the fault 115A-n, e.g., via application 165A-n on device 136A-n.

As further shown, BCS 110A can be communicatively coupled to other BCS's 110B-n, whereby, any of BCS's 110A-n can be configured to provide electrical energy to any of batteries 132A-n (e.g., respectively located onboard vehicle 130A-n). BCS's 110A-n can also be communicatively coupled to a central system 150, wherein central system 150 can be configured to receive/share/distribute charging availability at any of BCS's 110A-n, e.g., via schedules 152A-n, as further described. Further, one or more of the BCS's 110A-n can have businesses 155A-n identified as being local/proximate to a respective BCS 110A-n, such that, as further described, availability of one or more businesses 155A-n can be used to assist in determination of which BCS 110A-n an entity 134A-n selects/chooses to perform charging of respective battery 132A-n.

BCS 110A can further include a schedule component 118A and a clock/timer 119A, wherein, a clock 119A-n can be a digital clock/timer operating onboard a computer 180A-n operating at/communicatively coupled to BCS 110A-n, as further described. Schedule component 118A and clock 119A can be utilized to generate one or more charging schedules 120A-n. As mentioned, a schedule 138A-n can be implemented local to vehicle 130A-n, wherein a schedule 138A-n is available for viewing/interaction on device 136A-n. In an embodiment, a schedule 120A-n can also be respectively available for viewing/interaction at respective BCS's 110A-n, wherein a schedule 120A-n can include information regarding charging of vehicles 130A-n at the respective BCS 110A-n. For example, a first schedule 120A is a charging schedule for BCS 110A, a second schedule 120B is a charging schedule for BCS 110B, and suchlike. In another embodiment, a master charging schedule 152A-n can be utilized at the central system 150, whereby, master charging schedule 152A-n can be utilized to schedule charging of vehicles 130A-n (and onboard batteries 132A-n) at the various BCS's 110A-n, as further described. In an aspect, while different sets of schedules 120A-n, 138A-n, and 152A-n are presented herein, for ease of readability, sets of schedules 120A-n, 138A-n, and 152A-n, are also referenced in an omnibus term “schedule 154A-n”, such that an implemented first schedule 120A can also be applied to another schedule 138A, and a further schedule 152A. Further, information in respective schedules 154A-n can be shared/incorported into other schedules 154A-n to enable schedules 154A-n to contain current information for effective scheduling of charging of batteries 132A-n by any of BCS's 110A-n at any required/defined time.

It is to be appreciated that any components/devices described with regard to BCS 110A can also be present on the other BCSs 110B-n. Similarly, a computer system 180A-n can be located at any of the BCSs 110A-n.

As further described, each of BCSs 110A-n, vehicles 130A-n, devices 136A-n, central system 150, businesses 155A-n, etc., can further respectively include a computer system 180A-n, configured with memory, computer processor(s), etc., as required to facilitate operation of the respective BCS 110A-n, and interaction/sharing of schedules 154A-n between any of vehicles 130A-n, devices 136A-n, central system 150, BCSs 110A-n, and further, information (e.g., coupons 158A-n, compensation, and suchlike, as further described) between any of BCSs 110A-n, vehicles 130A-n, devices 136A-n, central system 150, businesses 155A-n, and suchlike.

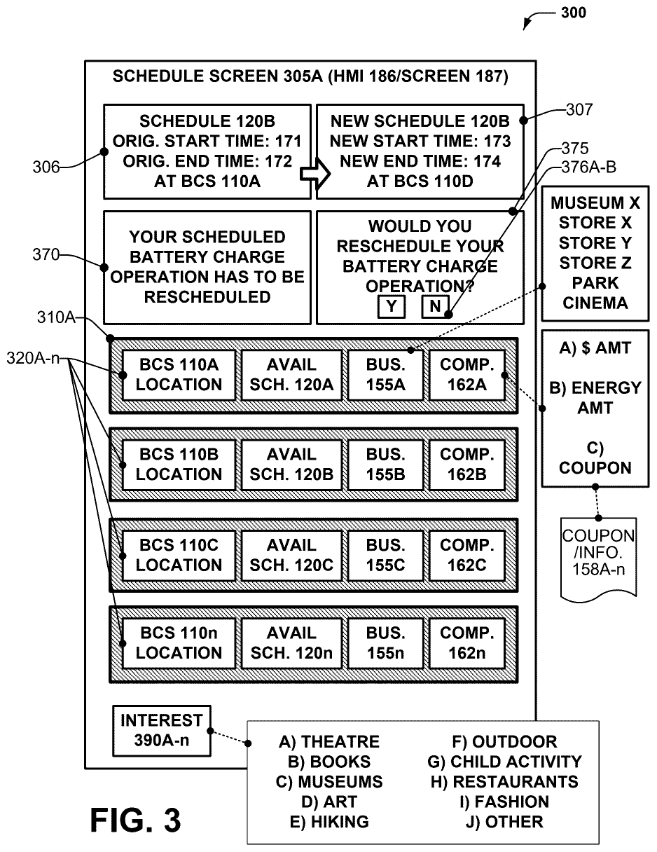

As shown, central system 150 can be configured to communicate with one or more businesses 155A-n, whereby a business 155A-n can provide information 159A-n regarding the location, hours, business type (e.g., store, museum, state park, vendor, etc.), etc., of the business 155A-n, and further provide a coupon/incentive 158A-n that can be redeemed by an entity 134A-n while waiting for the scheduled charging operation of battery 132A-n. As further described, coupons 158A-n can be associated with/presented (e.g., on screen 305A-n, per FIG. 3) based on the interests of entity 134A-n.

Accordingly, and as further described, the various embodiments presented herein enable one or more schedules 154A-n to be generated/amended to enable charging of batteries 132A-n at one or more of BCS's 110A-n over a range of timings, hours, days, etc.

Turning to FIG. 1C, system 100C provides further detail regarding the respective systems, components, devices, etc., of system 100 presented in FIGS. 1A-B, in accordance with one of more embodiments.

As previously mentioned, one or more schedules 154A-n can be utilized to enable adjustment/rescheduling of initially arranged schedules 154A-n, in conjunction with a charging configuration 124A-n. A charge configuration 124A-n can comprise a charging configuration/charging profile configured for charging of a battery 132A-n at a BCS 110A-n. For example, charge configuration 124A-n can include information regarding safe charging of the respective battery 132A-n, such as safe charging rate, etc., e.g., to prevent thermal and electric issues that could damage battery 132A-n, vehicle 130A-n, BCS 110A-n, etc. A charge configuration 124A-n can be generated (e.g., by schedule component 118A) in accordance with a schedule 154A-n, wherein charge configuration 124A-n can comprise slow charge, fast charge, etc., as required to safely charge a battery 132A-n within time defined in a schedule 154A-n.

Schedules 154A-n and charging configuration 124A-n, when initially generated can include a first start time 171A-n (aka original start time, initial start time) and a first end time 172A-n (aka original end time, initial end time) in conjunction with a first charging configuration 124A-n). In the event of an adjustment to a schedule 154A-n, the schedule 154A-n can be updated with any of a second start time 173A-n (aka updated start time, new start time), a second end time 174A-n (aka updated end time, new end time) in conjunction with a configuration 124A-n being updated as required, e.g., a fast charge of a battery 132A-n is added to the charging configuration 124A-n to enable charging of battery 132A-n to be achieved with an updated schedule 154A-n). Any of timings 171A-n/172A-n/173A-n/174A-n can be established in conjunction with clock 119A.

In an example embodiment, in the event of a fault 115A occurring (e.g., as detected by fault detection component 114) a corresponding temporary termination of charging of a battery 132A-n by BCS 110 also occurs. Charging is temporarily terminated until the fault 115A is acknowledged and reset, e.g., by activation of fault reset 116. Schedule component 118 can be configured to identify a no charge duration of time (NCD) 170 (e.g., from a first time, T₁, at which a fault 115A occurred and a second time, T₂, at which the fault 115A was addressed/reset and charging of battery 132A by BCS 110A is resumed), wherein NCD 170=T₂−T₁. NCD 170 indicates the duration/how long charging of battery 132A was not being performed, and accordingly, NCD 170 can indicate an amount of time that is required to be added to a schedule 154A-n to enable battery 132A to be charged to the required amount, e.g., full battery charge, 80% battery charge, and the like.

As previously mentioned, various options are available to facilitate the delayed charging of battery 132A, however, the various options can potentially impact a schedule of both the first entity 134A and also the second entity 134B (and any other entities 134C-n having to be rescheduled). For example, charging of battery 132A can be undertaken immediately, such that the current charging schedule 154A is simply extended by additional time equating to NCD 170A-n) while entity 134A waits at BCS 110.

However, the additional time NCD 170 can negatively impact a scheduled charging (e.g., schedule 120B, a second schedule) for the second entity 134B. Accordingly, various options are available to both first entity 134A and second entity 134B, whereby, in conjunction with addressing respective timings of the first schedule 154A and the second schedule 154B, to acknowledge/address the inconvenience of amended first schedule 120A and second schedule 120B, compensation 162A-n can be made available/provided to one or both of first entity 134A and second entity 134B.

In an embodiment, interaction between any of the entities 134A-n, BCS 110A-n, and central system 150 can be facilitated via a software application 165A-n available/operating on respective device 136A-n. Application 165A-n can provide information regarding a schedule 154A-n, e.g., a first schedule 138A is presented/available on device 136A for review/interaction by first entity 134A.

As shown in FIG. 1B, BCS 110A can further include a compensation component 160A configured to provide one or more scheduling options/compensations 162A-n to an entity 134A-n. Compensation 162A-n can be provided in various forms, e.g., a monetary amount, a free amount of energy, redeemable coupons, and other incentives. In an embodiment, entities 134A-n can have a user account 164A-n, whereby the user account 164A-n can be configured to receive/store selected compensation 162A-n, such that any payment/compensation can be applied to the user account 164A-n, e.g., for immediate or subsequent deposit into entity 134A-n's bank account. Compensation 162A-n can also include energy credits, such that the entity 134A-n can subsequently redeem the energy credits during a current/subsequent schedule 154A-n. User account 164A-n can further include a likes/dislikes of the entity 134A-n associated with the respective user account 164A-n, e.g., as further described with regard to FIG. 3, entry/selection of interest 390A-n.

In an embodiment, with a schedule component 118A-n respectively located at respective BCS's 110A-n, devices 136A-n, etc., a respective schedule component 118A-n can be configured to share schedules 154A-n. In an embodiment, a schedule component 118A-n can report current/past/future schedules 120A-n to the central system 150 (and/or directly to another BCS 110A-n) to enable the central system 150 to determine/identify charging availability of other BCS 110A-n, to enable the possibility of offering entity 134A-n the option of scheduling charging of battery 132A-n at a BCS 110A-n, either a BCS which was originally scheduled with or at an alternate BCS 110A-n, per the embodiments, presented herein.

BCS 110 can also include a data historian 184A configured to generate/update historical data 189A-n with any information regarding current/available/future/prior schedules 154A-n and charge configurations 124A-n, entity interests (e.g., interests 390A-n), available/redeemed coupons 158A-n, similarity indexes S₁₋ₙ, vectors Vₙ, and suchlike, on a HMI 186 (as further described). Historical data 190A-n can be utilized by a process component 193/one or more AI/ML processes 194A-n, etc., to determine/recommend a potential schedule 154A-n and/or charge configuration 124A-n to charge a battery 132A-n.

Various communications 197A-n can be utilized across system 100, between any of the BCSs 110A-n, VCCs 133A-n, devices 136A-n, central system 150, businesses 155A-n, and suchlike. Communications 197A-n can include notifications, instructions, selections (e.g., per interactive buttons 320A-n and 376A-n, per FIG. 3), notification of a fault 115A-n occurring/being cleared, schedules 154A-n, coupons 158A-n, compensations 162A-n, NCD 170A-n, timings 171A-n, 172A-n, 173A-n, and/or 174A-n, interests 390A-n, and suchlike, e.g., as input by entity 134A-n, generated by respective components in BCSs 110A-n, central system 150, businesses 155A-n, applications 165A-n/devices 136A-n, and suchlike

As further shown in FIG. 1C, any of BCS 110A-n, vehicles 130A-n (e.g., in respective VCC 133A-n), mobile devices 136A-n, central system 150, etc., can include/be respectively communicatively coupled to/comprise a computer system(s) 180A-n. For example, a computer system 180A is located at BCS 110A, computer system 180B is located at BCS 110B, computer system 180M is located in mobile device 136A, computer system 180K is located in central system 150, computer system 180L is located at business 155A, and suchlike. Respective computer system 180A-n can include a respective memory 182A-n configured to store the respective computer executable components (e.g., charger component 112A, fault detection component 114A, fault reset component 116A-n, schedule component 118A, clock 119A-n, compensation component 160A, data historian 184A-n, process component 193A, and suchlike, at BCS 110A; and comparable components located across system 100), and further, a respective processor 181A-n configured to execute the computer executable components stored in the memory 182A-n. Respective memory 182A-n can be further configured to store any of schedules 120A-n, 138A-n, 152A-n, 154A-n, fault 115A-n, charge configuration 124A-n, compensation 162A-n, processes 194A-n, coupons 158A-n, business information 159A-n, information in user accounts 164A-n, communications 197A-n and content of communications 197A-n, historical data 190A-n, similarity indexes S₁₋ₙ, vectors Vₙ, and suchlike (as further described herein).

Respective computer systems 180A-n can further include a human machine interface (HMI) 186A-n (e.g., a display, a graphical-user interface (GUI)) which can be configured to present various information including current/prior/future schedules 154A-n, information regarding charging fault 115A-n, coupons 158A-n, business information 159A-n, compensations 162A-n, charge configurations 124A-n, information in user accounts 164A-n, example screens 205A-n and 305A-n, lists 310A-n, charging resume buttons 240 and 250, interactive information/buttons 320A-n, reschedule buttons 376A-n, historical data 190A-n, similarity indexes S₁₋ₙ, vectors Vₙ, and suchlike, (as further described), per the various embodiments presented herein. HMI 186A-n can include an interactive display/screen 187A-n to present various information, e.g., screens 205A-n and 305A-n, lists 310A-n, interactive buttons 320A-n/376A-n/interests 390A-n.

Computer systems 180A-n can further include an I/O component 188A-n (and antenna 191A-n) to receive and/or transmit respectively current/prior/future schedules 154A-n, information regarding charging fault 115A-n, compensations 162A-n, charge configurations 124A-n, information in user accounts 164A-n, lists 310A-n, interactive information/buttons 320A-n, historical data 190A-n, similarity indexes S₁₋ₙ, vectors Vₙ, and suchlike. Any suitable technology can be utilized for interaction/communication by I/O 188, e.g., file transfer protocol (FTP), simple radio standalone (SRS), and suchlike.

While the forgoing relates to computer system 180A operating at BCS 110A, the respective systems BCS 110B-n, VCC's 133A-n, mobile devices 136A-n, central system 150, computer systems at businesses 155A-n, etc., can also include computer systems 180A-n, such that each of the respective systems BCS 110B-n, VCC's 133A-n, mobile devices 136A-n, central system 150, computer systems at businesses 155A-n, etc., comprise a respective processor 181A-n, memory 182A-n, HMI 186A-n, display 187A-n, I/O 188A-n.

BCS 110A-n can further include a process component 193, wherein process component 193 can be further configured to implement artificial intelligence (AI) and machine learning (ML) processes 194A-n. It is to be appreciated that processes 194A-n can comprise any AI/ML model/technology/technique/architecture utilized to automatically monitor operation of BCS′ 110A-n, occurrence and clearing of faults 115A-n, identifying one or more new schedules 154A-n for charging of batteries 132A-n on vehicles 130A-n, and suchlike.

Process component 193 can be utilized to implement processes 194A-n in conjunction with any of the other components included in BCSs 110A-n, central system 150, devices 136A-n, VCCs 133A-n, businesses 155A-n, and suchlike, and further generate/determine/infer one or more new schedules 154A-n, BCSs 110A-n to implement, a charge configuration 124A-n, prior schedules 154A-n, compensations 162A-n, timings 171-174, coupons 158A-n, etc., in historical data 190A-n, and suchlike (as further described).

FIG. 2 presents a schematic of an example fault screen 200, in accordance with one or more embodiments presented herein. As previously mentioned, when a fault 115A-n occurs during charging (e.g., of a battery 132A-n), a BCS 110A-n does not automatically restart the charging operation once the fault 115A-n is cleared. A BCS 110A-n may simply stop charging, which does not provide for good/efficient customer experience (e.g., customers 134A-n), particularly where customer 134A-n had a limited time to charge and the fault occurred prior to full use/charging by, for example, charger 112A of battery 132A, and the NCD 170A-n is of long duration. Per the various embodiments presented herein, a BCS 110A-n can notify, via screen 200, an entity 134A-n of the fault 115A occurring and that the fault 115A is now cleared, enabling the charging operation (e.g., per charge configuration 124A and schedule 120A) to be reset remotely, via device 136A or locally, e.g., by an entity 134M, manually resetting the charging operation at BCS 110A. By utilizing notifications 197A-n and fault screen 200, the fault condition 115A-n can be broadcast across a geographic area, enabling an entity 134A-n (e.g., driver of vehicle 130A, driver of vehicle 130B, another entity having a device 136A-n configured to receive the notifications 197A-n regarding fault 115A-n, a maintenance engineer/operation staff at the BCS 110A-n, and the like) to reset a fault condition to enable a battery charging operation (e.g., per charge configuration 124A-n and schedule 154A-n) to be resumed. Per the various embodiments presented herein, the interrupted charging of a vehicle 130A can be resumed to ensure that, at a minimum, battery 132A is charged to a minimum threshold for operation of vehicle 130A, in accordance with operational requirements determined by prospective use by entity 134A.

As shown, a fault screen 205 can be presented on any of devices 136A-n/applications 165A-n, a display 187A-n/HMI 186A-n at a respective BCS 110A-n, and the like. Fault screen 205 can include a first display region/indicator 210 configured to notify an entity 134A-n (e.g., owner of vehicle 130A-n undergoing charging) or system (e.g., BCS 110A-n, central system 150) of a fault 115A, e.g., as detected by fault detection component 114A. Indicator 210 can be a lighted region (e.g., colored red), flashing, etc., as required to obtain attention.

Second region/indicator 220 can be configured to notify an entity 134A-n that the fault 115A has been addressed and charging of vehicle 130A is awaiting to be resumed. Third region/indicator 230 can be configured to present options 240 (YES) and 250 (NO) regarding resuming/re-initiating the charging operation of battery 132A at BCS 110A. Selection of button 240 can cause the charging operation to be resumed, with a fourth region/indicator 260 being activated (e.g., colored green), indicating that “charging is underway/resumed”. Selection of button 250 can cause the charging operation to be cancelled, with a fifth region/indicator 270 being activated (e.g., colored green), indicating that “charging is cancelled”.

As mentioned, fault screen 205A can be presented on device 136A/application 165A, enabling review and interaction with the fault screen 205A by entity 134A, who owns vehicle 130A. In another example of use, fault screen 205A can be presented on device 136B/application 165B, enabling review and interaction with the fault screen 205A by entity 134B, who does not own vehicle 130A, but may have an interest in the charging operation resuming, e.g., entity 134B owns vehicle 130B, wherein vehicle 130B/battery 132B is scheduled for charging subsequent to charging of vehicle 130A/battery 132B. Alternatively, fault screen 205A can be presented at the BCS 110A, such that entity 134A can initiate resumption of recharging, or entity 134C who is present at the BCS 110A (e.g., having vehicle 130C recharged) and can initiate resumption of recharging, or further, entity 134M who is overseeing operation of the BCS 110A.

FIG. 3 presents a schematic of an example schedule screen 300, in accordance with one or more embodiments presented herein. As previously mentioned, entities 134A-n can be presented (e.g., via applications 165A-n) with various options regarding scheduling charging of battery 132A-n. Screen 300 presents an example of the respective information that can be presented to, and received from, an entity 134A-n. Per example screen 305A, an entity 134B (e.g., a second entity impacted by schedule 120A of entity 134A) can be presented with their current schedule 120B (e.g., at region 306 of screen 305A), whereby, as the schedule is adjusted, a new schedule 120B (e.g., at region 307 of screen 305A) can be presented on screen 305. Entity 134B can be supplied with a list 310A of the respective BCSs 110A-n available in the region, such that entity 134B is not confined to selecting only BCS 110A to charge battery 132B onboard vehicle 130B, but can select from BCSs 110A-n in the region of/vicinity of/proximate to BCS 110A and/or current/future location of entity 134B. List 310A can provide information regarding distance to BCS 110A-n, travel time required (e.g., based on current and/or historical traffic patterns). List 310A can further include information regarding scheduling/charging availability (e.g., per schedules 120A-n) at charging stations BCS 110A-n, from which entity 134B can review/select a schedule 120A-n that fits their personal availability. Further, a list of available businesses/interests 155A-n in the vicinity of a respective charging station BCS 110A-n, where, for example, in a non-limiting list, a store, a restaurant, a bar, a cinema, a theatre, a park, a museum, a library, and suchlike, in conjunction with hours, items of interest (e.g., current exhibit), etc., per information 159A-n. List 310A can also present any compensation 162A-n available with selection of a particular BCS 110A-n, where compensation 162A-n can include money, cryptocurrency, a redeemable coupon/incentive 158A-n, and suchlike. A coupon/incentive 158A-n can comprise of any suitable incentive, e.g., reduced ticket price, sale, a reduced % sale price, meal at price $XX.XX, and suchlike.

In a further embodiment, screen 305A-n can further include ability to enter/submit one or more interests 390A-n, to enable schedule component 118A to generate list 310A in accordance with the one or more interests 390A-n of entity 134A-n. Interests 390A-n can include any pursuits/items that may be of interest to entity 134A-n (e.g., wherein a dropdown list, or similar presentation technique can be used to present interests 390A-n for selection). Example interests include theatre, books, museum, art, hiking, outdoor, child activity, restaurants, fashion, etc. Entity 134A-n can further enter their own activity/interests (e.g., via example entry “(J) Other”.

As well as entering respective interests 390A-n, activity/interest(s) of entity 134A-n can also be monitored over time, with information (e.g., compiled in historical data 189A-n) utilized to determine whether another BCS 110A-n might be of interest to charge battery 132A-n, e.g., as a function vendor coupon 158A-n being redeemed, commonly selected BCS 110A-n, route taken by entity 134A-n, and suchlike.

As further mentioned, an AI/ML process component 193 and processes 194A-n can be included in any of BCS 110A-n, device 136A-n (e.g., coupled with application 165A-n), vehicle 130A-n (e.g., in VCC 133A-n), etc., wherein AI/ML processes 194A-n can assist schedule component 118 to determine one or more BCSs 110A-n of interest to entity 134A-n. Hence, with knowledge of entity 134A-n interests 390A-n, one or more charging schedules 154A-n at one or more BCSs 110A-n can be identified and/or presented to reduce inconvenience to entity 134A-n resulting from the initial delay in charging battery 132A-n. In an aspect, a coupon 158A-n can be an advertisement for business 155A-n regarding an item/activity of interest 390A-n, such as an advertisement from an art museum indicating a current exhibit (e.g., impressionist art is of interest to entity 134B but abstract expressionism is not), accordingly, the level of detail in interest 390A-n can be as detailed as entity 134A-n wishes to provide/determined by processes 194A-n.

In an example scenario of implementation of scheduling screen 305A, in an example scenario, an original schedule 154A-n (e.g., schedule 138B at device 136B, being a copy of schedule 120B at BCS 110A) can no longer be complied with for entity 134B, and a new schedule/amended schedule is required for entity 134B. Accordingly, a first message 370 can be presented on screen 305A instructing entity 134B to schedule a new time. In another example, an original schedule 154A-n can be complied with, but schedule component 118 has determined (e.g., in conjunction with processes 194A-n) that it would be easier if entity 134B rescheduled (e.g., a charging configuration 124A for battery 132A prior to the charging configuration 124B to be utilized for the battery 132B will have to implement fast charging to enable entity 134B's schedule to be honored at BCS 110A. Accordingly, a second message 375 can be presented on screen 305A requesting entity 134B to schedule an alternate time/location, with response via interactive buttons 376A (YES), 376B (NO).

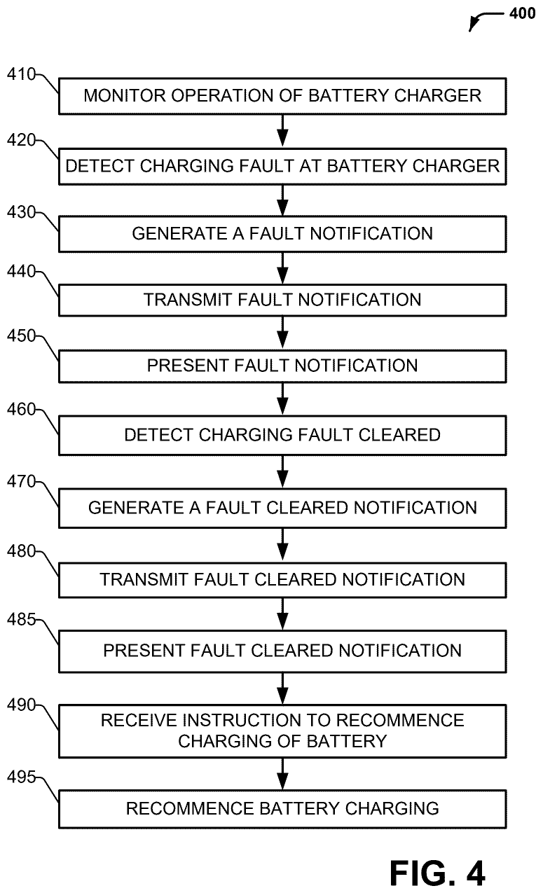

FIG. 4, via flowchart 400, presents an example computer-implemented method for scheduling a battery charging operation, in accordance with an embodiment.

At 410, operation of a battery charger (e.g., battery charger 112A) can be monitored (e.g., by fault detection component 114A) regarding charging of a battery (e.g., battery 132A) goes into a fault condition (e.g., fault condition 115A).

At 420, a fault condition, regarding the battery charging operation, is detected (e.g., by the fault detection component 114A/grid controller 141).

At 430, a fault notification (e.g., notification 197F) can be generated (e.g., by fault detection component 114A/grid controller 141).

At 440, the fault notification can be transmitted (e.g., by fault detection component 114A) to one or more devices and components (e.g., a device 136A-n, central system 150, schedule component 118A-n, and such) configured to facilitate interaction with the fault condition (e.g., resetting of the fault condition).

At 450, the fault notification can be presented on the respective device (e.g., on display 187B of device 136A).

At 460, the respective device can receive an input indicating that the fault has been cleared. The respective device can further generate a fault cleared notification (e.g., in communication 197C) and transmit the notification to the fault detection component.

At 470, in response to the fault being cleared, a fault cleared notification (e.g., notification 197C) can be generated by the fault detection component, indicating that the fault has been cleared.

At 480, the fault cleared notification can be transmitted, e.g., by the fault detection component, to one or more devices/systems (e.g., user devices 136A-n, central system 150, and the like).

At 485, the fault cleared notification can be presented on the one or more devices/systems, e.g., on a notification screen (as region 220 on display 187A-n) at devices 136A-n, on a notification screen at a BCS 110A-n.

At 490, a resume charging instruction (e.g., instruction 197S) can be received at the notification screen (e.g., entity 134A selects the YES button 240). The resume charging instruction can be received at the fault reset component (e.g., fault reset component 116), wherein the fault reset component can be configured to clear the fault/resume the charging operation, e.g., via a resume charging notification (e.g., notification 197R) transmitted to the charger (e.g., charger 112).

At 495, in response to receipt of the resume charging notification, a charger can be configured to resume charging of the battery.

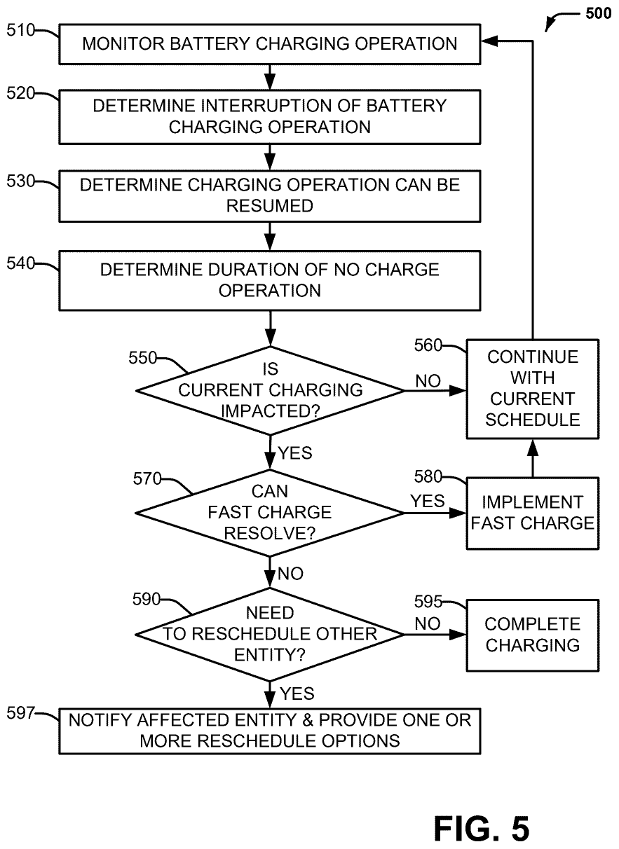

Turning to FIG. 5, via flowchart 500, presents an example computer-implemented method for scheduling a battery charging operation, in accordance with an embodiment.

At 510, a battery charging operation can be monitored (e.g., by fault detection component 114/schedule component 118A), wherein the battery charging operation can be performed in accordance with a schedule (e.g., schedule 120A-n) and a charging configuration (e.g., charging configuration 124A-n).

At 520, an interruption to the charging operation can be detected (e.g., by the fault detection component 114A detecting a fault 115A, instruction from grid controller 141, and such).

At 530, a determination (e.g., by fault reset component 116A) can be made that the fault has been cleared/reset and the charging operation can be resumed.

At 540, a determination (e.g., by the schedule component 118A) can be made regarding how much time was lost (e.g., NCD 170A-n) during the fault condition of the charging operation.

At 550, a determination can be made (e.g., by the schedule component 118A) regarding whether the current charging operation is impacted. In response to a determination that NO, the current charging operation was not impacted by the charging operation (e.g., the lost charging time, NCD 170A, does not cause an overrun of the current charging schedule). Method 500 can advance to 560, whereupon charging of the battery, with the current schedule, can be resumed. Method 500 can return to step 510 for further monitoring of the charging operation, e.g., until charging is complete/duration of charging terminates).

At 550, in response to a determination (e.g., by the schedule component 118A) that, YES, the current charging schedule is impacted, e.g., the duration of the fault condition causes an overrun of the current charging schedule, method 500 can advance to 570, whereupon a determination (e.g., by the schedule component 118A) can be made regarding whether a period of fast charging (e.g., applying a fast charge to a charge configuration 124A) of the battery can ensure the current charging operation can be completed within the scheduled time. In the event of a determination that YES, fast charging can resolve the lost time arising from the fault condition, method 500 can advance to step 580, whereupon fast charge can be implemented.

At 570, in response to a determination (e.g., by the schedule component 118A) that NO, a fast charge operation will not resolve the lost time of the scheduled charging operation, method 500 can advance to step 590, whereupon a determination can be made (e.g., by schedule component 118A) regarding whether the defaulted charging operation (e.g., in charge configuration 124A) impacts a scheduled charging operation for another entity (e.g., driver 134B). In response to a determination (e.g., by schedule component 118A) that there is NO impact to any other charging operation, method 500 can advance to step 595, whereupon the current charging operation can be completed.

At 590, in response to a determination (e.g., by schedule component 118A) that YES, another scheduled charging operation is impacted, method 500 can advance to step 597, whereupon a notification (e.g., in communication 197N) can be transmitted to the affected entity, wherein the notification can include/provide one or more options for rescheduling, e.g., different time at current location, different time at different location, current time but at a different location, and the like.

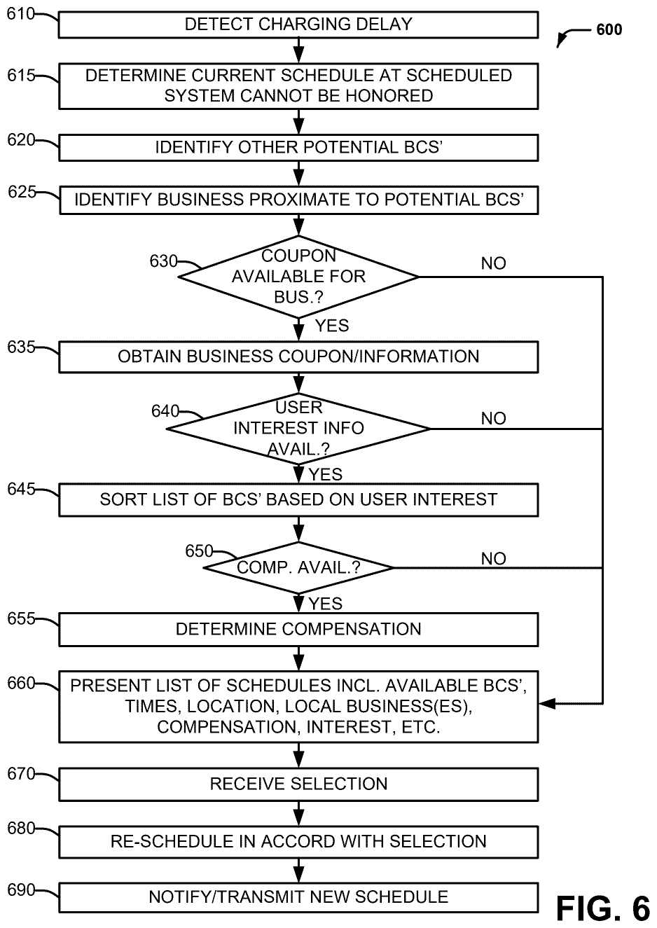

FIG. 6, via flowchart 600, presents an example computer-implemented method for scheduling a battery charging operation, in accordance with an embodiment.

At 610, a battery charging delay can be detected (e.g., by schedule component 118A) regarding a currently implemented/first scheduled battery charging operation (e.g., first schedule 120A), being performed on a first battery (e.g., battery 132A) located onboard a first vehicle (e.g., vehicle 130A), at a first battery charging station (e.g., BCS 110A). E.g., a charging fault occurred causing an overrun of the current schedule.

At 615, the schedule component can be configured to determine that, owing to the overrun of the current schedule, a subsequent/second battery charging operation (e.g., second schedule 120B) at the first battery charging station cannot be honored, e.g., subsequent battery charging operation is scheduled to start prior to the current schedule ending. The subsequent battery charging operation is to be performed on a second battery (e.g., battery 132B) located onboard a second vehicle (e.g., 130B).

At 620, in response to determining the second battery charging schedule cannot be honored, the schedule component can be further configured to identify other potential battery charging stations (e.g., BCS 110B-n), including the currently scheduled BCS (e.g., BCS 110A).

At 625, as part of determining other potential BCSs for charging a battery, the schedule component can be further configured to identify businesses (e.g., businesses 155A-n and associated information 159A-n) local to the one or more available BCSs can be determined.

At 630, in response to the schedule component identifying one or more businesses local to a respective BCS, the schedule component can be further configured to determine whether any of the local businesses are offering an incentive, a coupon (e.g., coupon 158A-n), a promotion, and the like. In response to a determination that YES, a coupon is available, method 600 can advance to step 635, whereupon the coupon, and information (e.g., information 159A-n) regarding the business, can be obtained (e.g., from the business 155A-n) by the schedule component, or a central system (e.g., central system 150).

At 640, the schedule component can be further configured to determine whether user interest information (e.g., interest information 390A-n) is available (e.g., received via schedule screen 305A). In response to a determination by the schedule component that YES, user interest information is available, method 600 can advance to step 645 whereupon, the potential BCSs can be sorted into a list (e.g., list 310A) based on the user interest information, e.g., BCS most closely matching the user interest is listed first, BCS least matching the user interest is listed last.

At 650, the schedule component can be further configured to determine whether compensation (e.g., compensation 162A-n) is available, e.g., for the inconvenience of having to reschedule the battery charging operation. In response to a determination by the schedule component that YES, compensation is available, method 600 can advance to step 655, whereupon the compensation can be determined.

At steps 630, 640, and/or 650, in response to a determination that NO, none of a coupon, user interest, or compensation are available, method 600 can advance to step 660.

At 660, a list of available schedules (e.g., list 310A) can be presented (e.g., on schedule screen 305A), wherein the list of schedules can include one or more available BCSs, available time(s), location of each BCS, businesses local to the respective BCS, available compensation, user interest, etc., and the list can be further sorted based on any of the prior information, e.g., with regard to user interest, compensation, etc.

At 670, a schedule selection can be received (e.g., via schedule screen 305A on display 187A-n and HMI 186A-n), whereby an entity (e.g., owner 134B of vehicle 130B) can indicate that YES (e.g., selection 376A on screen 305A) the entity wants to reschedule, and further selects their preferred selection (e.g., via interactive information/buttons 320A-n) from the list of available BCS′ (e.g., list 310A).

At 680, the schedule component can be further configured to re-schedule the battery charge operation (e.g., of battery 132B) in accordance with the received selection.

At 690, the schedule component can be configured to generate and transmit a notification (e.g., notification 197R) regarding the new schedule (e.g., updated schedule 120B) and further transmitted to the user (e.g., via device 136B, application 165B), to the central system (e.g., central system 150), to the schedule component (e.g., schedule component 118D) located at the selected BCS (e.g., BCS 110D), etc.

It is to be appreciated that while the foregoing are directed towards the schedule component being configured to identify/determine the alternate BCS being used for the subsequent charging operation, the various operations, etc., described above, can be performed by the central system 150 as a function of rescheduling a battery charging operation at a first scheduled BCS 110A, as well as rescheduling at any of the other available BCS′ 110B-n.

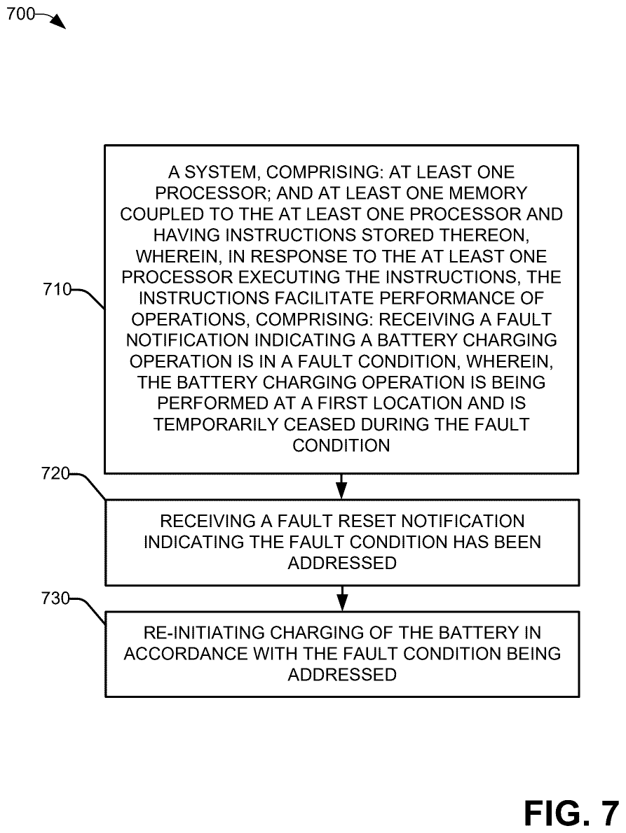

FIG. 7, via flowchart 700, presents an example computer-implemented method for scheduling a battery charging operation, in accordance with an embodiment, in accordance with one or more embodiments. At 710, the process 700 can comprise a system, comprising at least one processor (e.g., processor 181A-n), and at least one memory (e.g., memory 182A-n) coupled to the at least one processor and having instructions stored thereon, wherein, in response to the at least one processor executing the instructions, the instructions facilitate performance of operations, comprising: receiving a fault notification (e.g., notification 197A-n) indicating a battery charging operation (e.g., being performed at battery charging system 110A-n on battery 132A-n) is in a fault condition (e.g., fault condition 115A), wherein, the battery charging operation is being performed at a first location and is temporarily ceased during the fault condition. At 720, process 700 can further comprise receiving a fault reset notification (e.g., notification 197A-n) indicating the fault condition (e.g., fault condition 115A) has been addressed. At 730, process 700 can further comprise re-initiating charging of the battery in accordance with the fault condition being addressed.

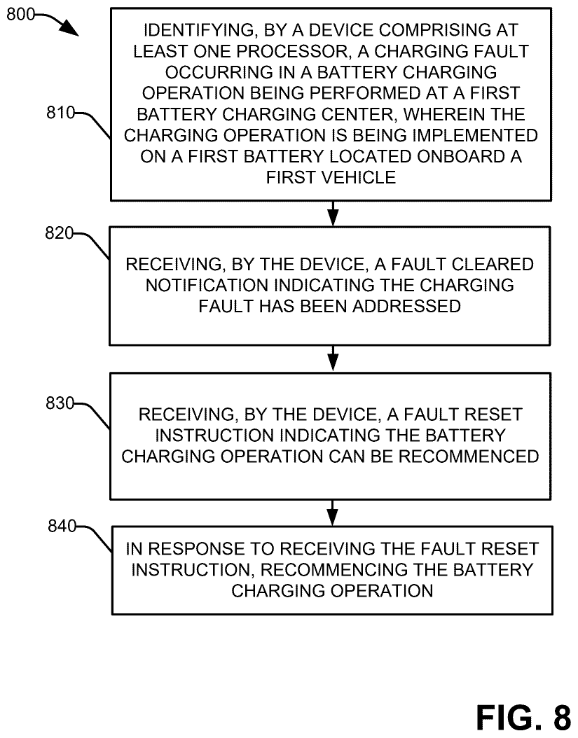

FIG. 8, via flowchart 800, presents an example computer-implemented method for scheduling a battery charging operation, in accordance with one or more embodiments. At 810, the process 800 can comprise identifying, by a device comprising at least one processer (e.g., processor 181), a charging fault (e.g., fault condition 115A) occurring in a battery charging operation being performed at a first battery charging center (e.g., being performed at battery charging system 110A), wherein the charging operation is being implemented on a first battery (e.g., battery 132A) located onboard a first vehicle (e.g., vehicle 130A). At 820, process 800 can further comprise receiving, by the device, a fault cleared notification (e.g., notification 197A-n) indicating the charging fault has been addressed. At 830, process 800 can further comprise receiving, by the device, a fault reset instruction (e.g., notification 197A-n from fault reset component 116A) indicating the battery charging operation can be recommenced. At 840, process 800 can further comprise, in response to receiving the fault reset instruction, recommencing the battery charging operation.

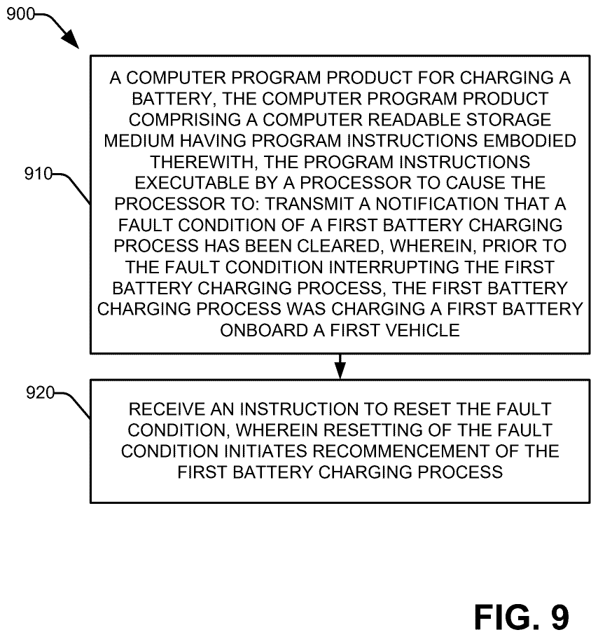

FIG. 9 presents an example computer-implemented method for scheduling a battery charging operation, in accordance with one or more embodiments, in accordance with one or more embodiments. At 910, process 900 can include a computer program product for charging a battery (e.g., battery 132A) can be utilized, wherein the computer program product comprising a computer readable storage medium (e.g., memory 182A-n) having program instructions embodied therewith, the program instructions executable by a processor (e.g., processor 181A-n) to cause the processor to: transmit a notification (e.g., notification 197A-n) that a fault condition (e.g., fault condition 115A) of a first battery charging process has been cleared, wherein, prior to the fault condition interrupting the first battery charging process, the first battery charging process was charging a first battery (e.g., battery 132A) onboard a first vehicle (e.g., vehicle 130A). At 920, process 900 can further include the program instructions executable by a processor to further cause the processor to receive an instruction to reset the fault condition (e.g., via fault reset component 116A), wherein resetting of the fault condition initiates recommencement of the first battery charging process.

### 5. Application/Implementation of AI & ML

As mentioned, the various embodiments presented herein can utilize various artificial intelligence (AI)/machine learning (ML) models/technologies/techniques/architecture (e.g., process component 193 implementing processes 194A-n). AI/ML technologies and techniques can be configured to determine information, make inferences, predictions, etc., regarding automatically identifying and configuring one or more schedules 154A-n of interest during rescheduling of a battery charging operation at one or more BCSs 110A-n.

Processes 194A-n can include AI, ML, and reasoning techniques/technologies that employ probabilistic and/or statistical-based analysis to prognose or infer an action that an entity desires to be automatically performed for carrying out various aspects thereof, e.g., automatically identifying a potential charging schedule 154A-n based on an interest 390A-n of an entity 134A-n, a previously implemented schedule 154A-n, a business 155A-n, an incentive such as a redeemable coupon 158A-n or a compensation 162A-n, and suchlike, which can be facilitated via an automatic classifier system and process.

As used herein, the terms “predict,” “infer,” “inference,” “determine,” and suchlike, refer generally to the process of reasoning about or inferring states of the system, environment, and/or user from a set of observations as captured via events and/or data. Inference can be employed to identify a specific context or action, or can generate a probability distribution over states, for example. The inference can be probabilistic-that is, the computation of a probability distribution over states of interest based on a consideration of data and events. Inference can also refer to techniques employed for composing higher-level events from a set of events and/or data. Such inference results in the construction of new events or actions from a set of observed events and/or stored event data, whether or not the events are correlated in close temporal proximity, and whether the events and data come from one or several event and data sources.

A classifier is a function that maps an input attribute vector, x=(x1, x2, x3, x4, xn), to a class label class(x). The classifier can also output a confidence that the input belongs to a class, that is, f(x)=confidence(class(x)). Such classification can employ a probabilistic and/or statistical-based analysis to prognose or infer an action that a user desires to be automatically performed (e.g., identifying a potential charging schedule 154A-n based on an interest 390A-n of an entity 134A-n, and suchlike).

A support vector machine (SVM) is an example of a classifier that can be employed. The SVM operates by finding a hypersurface in the space of possible inputs that splits the triggering input events from the non-triggering events in an optimal way. Intuitively, this makes the classification correct for testing data that is near, but not identical to training data. Other directed and undirected model classification approaches include, e.g., naïve Bayes, Bayesian networks, decision trees, neural networks, fu16y logic models, and probabilistic classification models providing different patterns of independence can be employed. Classification as used herein is inclusive of statistical regression that is utilized to develop models of priority.

As will be readily appreciated from the subject specification, the various embodiments can employ classifiers that are explicitly trained (e.g., via a generic training data) as well as implicitly trained (as further described below). For example, SVM's are configured via a learning or training phase within a classifier constructor and feature selection module, e.g., included in process component 193. Thus, the classifier(s) can be used to automatically learn and perform a number of functions, including but not limited to determining according to predetermined criteria, e.g., identifying a potential charging schedule 154A-n based on an interest 390A-n of an entity 134A-n, and suchlike.

In an example embodiment, processes 194A-n can be trained/fine-tuned with previously obtained/generated data (e.g., in historical data 189A-n, previously implemented schedules 154A-n, an interest 390A-n of an entity 134A-n, a local business 155A-n, an incentive such as a redeemable coupon 158A-n or a compensation 162A-n, and such). Fine-tuning of a process 194A-n can comprise application, to processes 194A-n, of previously implemented schedules 154A-n (e.g., preferred day/time, preferred location, etc.), entity interests 390A-n, businesses 155A-n (e.g., new museum opening at location BCS 110F), available incentive (e.g., selection of a coupon 158A-n, selection of compensation 162A-n), a pending/planned journey/route during which local BCSs 110A-n can be identified, and the like. Processes 194A-n can be correspondingly adjusted by the ability of the processes 194A-n (process component 193, and any associated component across scheduling system 100 utilizing processes 194A-n) to successfully/or unsuccessfully determine any of a previously defined schedule 154A-n that corresponds, satisfies, or substantially satisfies, a similarity criterion pertaining to/determined for a current/future battery charging operation for which a schedule 154A-n is being configured. For example, weightings in the process 194A-n are adjusted by application of the ability to accurately determine a previously defined schedule 154A-n/prior list 310A-n that is suitable for application with determining a current/future schedule 154A-n, and such. During training, prior decisions, prior observations, determinations, etc., can be applied to the processes 194A-n, enabling the processes 194A-n to be trained regarding correctly identifying a prior schedule 154A-n applicable for use with any of entity interest 390A-n, etc., that may influence selection of a current/future schedule 154A-n for an entity 134A-n. Accordingly, when new information is provided (e.g., a schedule 154A-n being implemented, selection of a business 155A-n, selection of a coupon 158A-n, selection of a compensation 162A-n, new availability of any of a business 155A-n, location of a BCS 110A-n, coupon 158A-n, compensation 162A-n, and suchlike), processes 194A-n can be retrained accordingly.

In another example, process component 193A can operate in conjunction with the central system 150 to review pending charging schedules 154A-n at the respective BCSs 110A-n, and can further determine if a particular BCS 110A-n is being under-utilized, has an available schedule, and the like, and generate a compensation 162A-n that incentivizes an entity 134A-n to schedule a battery charging operation at the identified BCS 110A-n.

It is to be appreciated that the various processes 194A-n and operations presented herein are simply examples of respective AI and ML operations and techniques, and any suitable technology can be utilized in accordance with the various embodiments presented herein. In an example embodiment, process component 193/processes 194A-n can be applied to any of previously implemented, current, or future schedules 154A-n, charge configurations 124A-n, business information 159A-n, interests 390A-n, etc., in historical data 189A-n, and such. Wherein, process component 193/processes 194A-n can include a vector component to apply any suitable vectoring technology, such as, in a non-limiting list, bag of words (BOW) text vectors, Euclidean distance, cosine similarity, vector representation via term frequency-inverse document frequency (tf-idf) capturing term/token frequency (e.g., common terms across prior/current/future knowledge), neural network embedding layer vector representation of terms/categories (e.g., common terms having different tense), a transformer neural network, bidirectional and auto-regressive transformer (BART) model architecture, a bidirectional encoder representation from transformers (BERT) model, long short term memory network (LSTM) operation(s), a sentence state LSTM (S-LSTM), a deep learning algorithm, a sequential neural network, a sequential neural network that enables persistent information, a recurrent neural network (RNN), a convolutional neural network (CNN), a neural network, capsule network, a machine learning algorithm, a natural language processing (NLP) technique, sentiment analysis, bidirectional LSTM (BiLSTM), stacked BiLSTM, regular pattern expression matching, and suchlike. Language models, LSTMs, BARTs, etc., can be formed with a neural network that is overly complex, for example, comprising billions of weighted parameters.

Accordingly, in an embodiment, implementation of system 100 and included/associated components, with processes 194A-n, enables natural language processing (NLP) (e.g., utilizing vectors) to identify a previously implemented schedule 154A-n that may be of interest to an entity 134A-n in selecting a new charging schedule 154A-n.

During application of processes 194A-n, vector representations V₁₋ₙ can be applied to any of prior and current schedules 154A-n, entity interest(s) 390A-n, local business 155A-n, an incentive such as a redeemable coupon 158A-n or a compensation 162A-n, and suchlike, such that vector similarity operations (e.g., vector clustering/distancing) can be applied to recommend a battery charging schedule 154A-n. The degree of similarity (e.g., via similarity indexes S₁₋ₙ) between respective information can be determined, for example, based on a threshold reflecting a proximity of a first vector generated from information (e.g., in historical data 189A-n) pertaining to implementation of a prior schedule 154A to a to-be-defined pending schedule 154B, e.g., regarding timings (day/time), user entity interest(s) 390A-n, local business 155A-n, an incentive such as a redeemable coupon 158A-n or a compensation 162A-n, and suchlike.

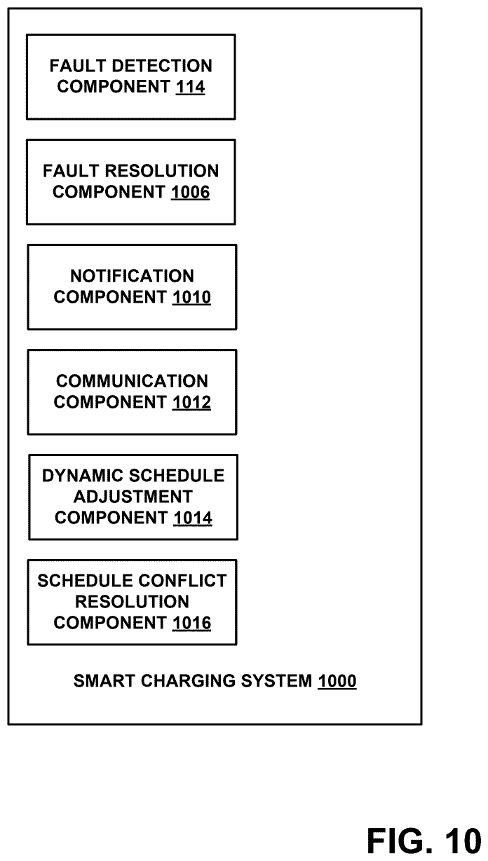

Turning now to the drawings, FIG. 10 illustrates a block diagram of an exemplary smart charging system 1000 that facilitates a battery charging and addressing requirement of manual reset to resume charging upon an occurrence of a charging fault at the battery charging system 110A during a charging session for the battery 132A-n.

In an aspect, a smart charging system 1000 comprises a fault detection component 114, a fault resolution component 1006, a time tracking component 1008, a notification component 1010, a communication component 1012, a dynamic schedule adjustment component 1014 and a schedule conflict resolution component 1016. The smart system disclosed herein solves a technical solution to the technical problem that impacts charging for the current session, as well as subsequent scheduled session and how to notify and negotiate new parameters required for adjusted charging session. An aspect of the technical solution is that when a fault during the charging session occurs, the system attempts to resolve the issue. If the time required to resolve the fault is higher than threshold, the system adjusts the parameters of the current charging session and notifies the user of the current session. The parameter adjustments can be reduced charge due less time, increase in charging speed to reach the desired charge level due to reduction in charge time, adjusting charging session time (e.g., adjusting time to complete the desired charge level) to account for loss of time due to occurrence of fault, and combination of all of the above. In aspect, if the charging session time adjustment is the best option, the system will notify subsequent scheduled charging session users of the impact on their sessions. The system may negotiate in one or more subsequent scheduled charging session users to return to unadjusted charging sessions (e.g., return to normal before the delay caused by the occurrence of the fault).

The advantage of the solution provided by the smart EV charging system is that it provides a rapid fault detection and resolution to minimize downtime, the EV owners stay informed about system status, the adjusted schedules prevent unfair delays for subsequent users, and the system can be deployed across multiple charging stations.

The fault detection component 114 continuously monitors EV charging sessions. When a fault occurs, fault detection component 114 identifies the fault promptly. The fault types include hardware issues at the charging station, communication errors, power supply irregularities, or weather impact at the charging station.

Upon detecting a fault, the fault resolution component 1006 initiates correction actions, provides visual indication that charging has stopped and determines if a manual restart is required to resume charging. In an aspect, the system provides visual indication at the charging station (e.g., flashing red light to indicate that charging has stopped due to an occurrence of fault). The system also communicates the occurrence of the operator of the charging stations to initiate reset protocols or other resolution protocols (e.g., re-establishing connections, resetting charging stations, adjusting power levels, etc.). Upon identifying a resolution, the operator may remotely attempt to reinitiate the charging. However, if the operator is not able to re-initiate charging remotely, the user of the currently scheduled session is notified to manually restart the charging. In addition, a visual indication is provided at the charging station to allow others passing by to manually restart the charging. In an aspect, the charging station may broadcast messages to others nearby requesting a manual restart of the stranded charger. For example, once the resolution is implemented to clear the fault and remote restart is not available, the charging station illuminates green flashing light at the charging station and a button that can be activated to restart charging. In addition, the system can broadcast location of the charging station, charging station number and instruction on how to restart the charging using wireless communication protocols (e.g., using near field communication such as Wifi/Bluetooth/NFC to send messages to nearby communication devices, including other cars). The broadcast and visual indication may continue periodically until manual reset has been performed.

The time tracking component 1008 records the time taken to resolve each fault. This information is crucial for system optimization and performance evaluation. The time tracking data is stored in memory for use with adjusting charging session time.

In an aspect, the notification component 1010 utilizes various wireless communication protocols to transmit messages to notify occurrence of the fault and requests to reset the fault manually if determined that manual restart is required to resume charging. The notification component 1010 utilizes the communication component 1012 and various wireless communication protocols to transmit messages to the current owner of the charging session. If no response is received in a timely manner, the notification component 1010 initiates a visual alert protocol to seek assistance from others nearby. In an aspect, the visual alert protocol comprises illumination of flashing light at the charging station. In another aspect, the visual alert protocol comprises transmitting signals to the connected car to illuminate one or more lights of the connected car. In an aspect, in addition to initiating visual protocol, the notification component 1010 utilizes the communication component 1012 and various wireless communication protocols to transmit messages to cars connected to other charging stations connected to the same group as the distressed charging station.

In another aspect, the notification component 1010 utilizes various wireless communication protocols to transmit messages to notify occurrence of the fault, requests to reset the fault, notify the current user that an adjustment may be required to maintain the original requested charge level. For example, the EV owner receives real-time notifications when a fault occurs. The notifications include fault details, estimated resolution time, and any adjustments to the charging schedule. The notification channels may be selected by the users (e.g., users may choose SMS, text, mobile app, or email) to receive notification of fault and schedule adjustments. In an aspect, the notification message includes, timestamp of fault occurrence, fault resolution time, adjusted charging session parameter with options to choose an adjustment (e.g., low charge amount, higher charging speeds, extension of time, or combination of the above), and request for acceptance (e.g., prompt for the EV owner and subsequent users to accept the adjusted schedule. In an aspect, system may offer the current user an adjusted charging schedule (e.g., original end time 2:00 pm to new end time 2:15 pm), faster charging speed (e.g., standard charge speed to fast charging speed), or price adjustment with monetary reward of taking less charging time. In an aspect, before offering a faster charging speed, the system considers the health of the battery and impact on the battery if fast charge is used. In an aspect, before offering price adjustments or reductions in charge option, the system considers the user need of the charge level. For example, if the user requires a certain charge to get home and return without any additional charging, the system may not offer a reduction in charge. The system may offer extension of charging sessions or fast charging. In an aspect, the notification component 1010 may notify the EV owner via the vehicle's display or a mobile app, explaining the fault and the adjusted schedule, the charging station operator responsible for dispatching maintenance personnel, and/or grid operator for a large-scale charging network, where the system communicates with the grid operator to manage load distribution (e.g., identifying available charging stations nearby).

The dynamic schedule adjustment component 1014, after fault resolution, recalculates parameters for remaining charging sessions for the current user. In an aspect, the schedule adjustment component considers, time required for fault resolution, impact on the current schedule and subsequent schedules, acceptance by the current user on the adjusted schedule and acceptance by the subsequent users impacted by the adjusted schedule. The schedule adjustment component ensures fairness among all users sharing the charging infrastructure. The schedule adjustment component may use AI models to determine price adjustments and future credits. Prior to implementing the new charging schedule, the schedule adjustment component communicates and negotiates the proposed schedule to the current owner and impacted owners of subsequent charging sessions. Upon final confirmation, the schedule adjustment component adjusts current and subsequent charging sessions.

In an aspect, the dynamic schedule adjustment component 1014, upon detecting a fault (e.g., a faulty connector or unstable voltage), and time it took to resolve the fault, the dynamic schedule adjustment component 1014 adjusts the charging schedule to compensate for the delay. For example, If the original schedule were to charge from 8:00 PM to 10:00 PM, it extends the end time to 10:10 PM. Alternatively, it redistributes the remaining charging time across subsequent sessions. The main goal of the system is to ensure that the battery reaches the desired state of charge despite the interruption caused by the fault. Once the new schedule is determined, the new schedule is communicated to the current session owner. The system may go through several rounds of communication prior to implementing the new schedule.

In an aspect, a schedule conflict resolution component 1016 utilized to access the current EV owner's existing charging schedule. The schedule conflict resolution component 1016 checks for conflicts between the adjusted schedule and the EV owner's other commitments (e.g., appointments, work hours, distance to home, etc.). The schedule conflict resolution component 1016 continues to monitor EV owner schedules to identify additional conflicts that may impact the adjusted charging session.

In an aspect, a communication component 1012 generates a manual reset request message comprising location of the charger and instructions how to restart charging based on fault type. The manual reset request message is transmitted to the owner of the current scheduled owner. When no response is received after a predetermined time, the manual reset request message is broadcasted to other devices and vehicles. The purpose of the broadcast of the message is to seek assistance from others nearby. As the EV community expands, more devices and vehicles may be configured to receive the manual reset request message.

In an aspect, a communication component 1012 is utilized to communicate information to the current owner of the charging session and one or more subsequent impacted owners of the charging session. For example, the first owner of EV schedules a charge time from 8:00 AM-10:00 AM at the first charging station which is part of a cluster of charging stations at the first location. At the time of scheduling, each EV owner provides information to the charging station. In an aspect, using a mobile app the EV owner provides VIN, owner contact information, schedule time, desired charge amount, payment information, access to battery health, owner's schedule information (e.g., calendar, appointments for one or more days, etc.). The information provided by the owner is stored in memory and retrieved in the event necessary to adjust the scheduled charge session. In an aspect, the communication component 1012 may access and utilize one or more components of the vehicle that is connected to the charger. For example, the charging station may use communication component (not shown) of the vehicle to transmit a messages to the owner of the vehicle.

In an aspect, when a fault occurs, the system using the communication component 1012 communicates with the owner of the current charging session (e.g., the first owner). For example, a message comprising time of fault and status of charging transmitted to the owner's mobile app or device and displayed on the infotainment screen of the vehicle.

In an aspect, if the charging system requires a manual reset, the notification component 1010 utilizes the communication component 1012 to provides a visual alert at the charging station and transmits a request to manually reset charging message to nearby mobile devices, vehicles capable of receiving the request to manually reset charging message, and to the current owner of the charging session (e.g., first owner). The message may include a notification that the charging station requires a manual reset and instructions on how to manually reset the charging.

Once the fault is resolved, charging has restarted, and the dynamic schedule adjustment component 1014 has determined an adjustment scenario, the first new adjustment scenario is offered to the current owner. The updated schedule message comprises an updated schedule, and one or more options as alternatives to updated schedule. The updated schedule message is transmitted to the owner's device and connected vehicle. The options may include, a first option offers to end charging according to original end time and accept lower charge amount, a second option offers to end charging according to original end time and increase charging speed to receive original request amount of charge, third option offers an adjusted end time to account of time it took to restart charging. In an aspect, the schedule adjustment response message is received comprising an acceptance of one of the options. If the schedule adjustment response message indicates acceptance of option 1 or 2, the system implements the actions accordingly. However, if option 3 is accepted, the system generates additional messages to notify owners of subsequent charging sessions. For example, an updated subsequent schedule message comprising a first subsequent option, a second subsequent option, and a third subsequent option. The first subsequent option offers to delay start time with original end time resulting in lower charge amount. The second subsequent option offers to delay start time with the original charge amount using a faster charge speed. The third option offers an adjusted start and end time based on delay due to fault resolution. In an aspect, the schedule conflict resolution component 1016 determines if the any of the options described above conflicts with the owner's personal schedule.

It should be noted that the options mentioned above are exemplary. In an aspect, the system may conduct several rounds of communication and generate additional options that offer various adjustments to ensure fairness for all users. The system will use AI models, access battery health, access user appointments and requirements to determine acceptable charge amounts and generate options accordingly.

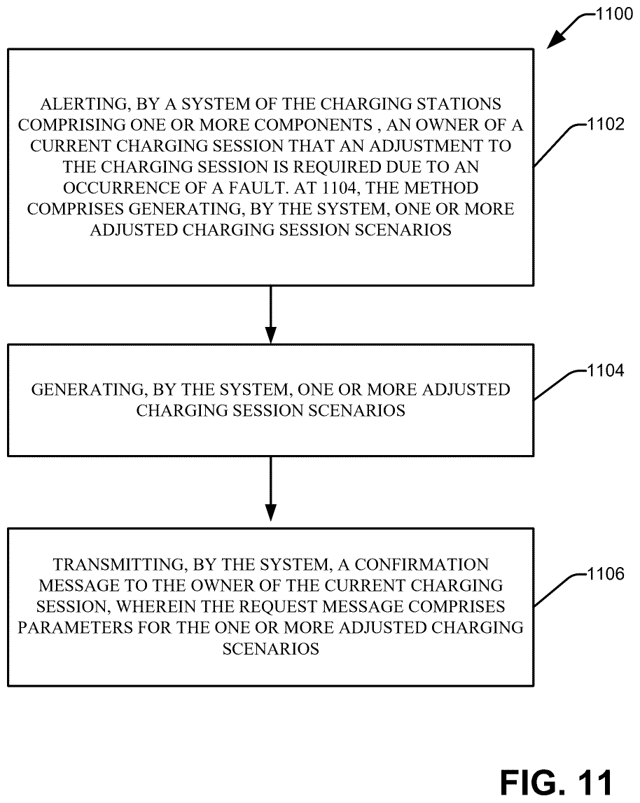

FIG. 11 illustrates a block flow diagram of another example, non-limiting computer-implemented method 1100 for facilitate addressing a fault condition, in accordance with one or more embodiments described herein. As an example, method 1100 can be executed by an electronic computer unit of charging station or a vehicle. Method 1100 comprises, at 1102, alerting, by a system of the charging stations comprising one or more components (e.g., the notification component), an owner of a current charging session that an adjustment to the charging session is required due to an occurrence of a fault. At 1104, the method comprises generating, by the system (e.g., the dynamic schedule adjustment component), one or more adjusted charging session scenarios. At 1106, the method comprises transmitting, by the system (e.g., the communication component component), a confirmation message to the owner of the current charging session, wherein the request message comprises parameters for the one or more adjusted charging scenarios.

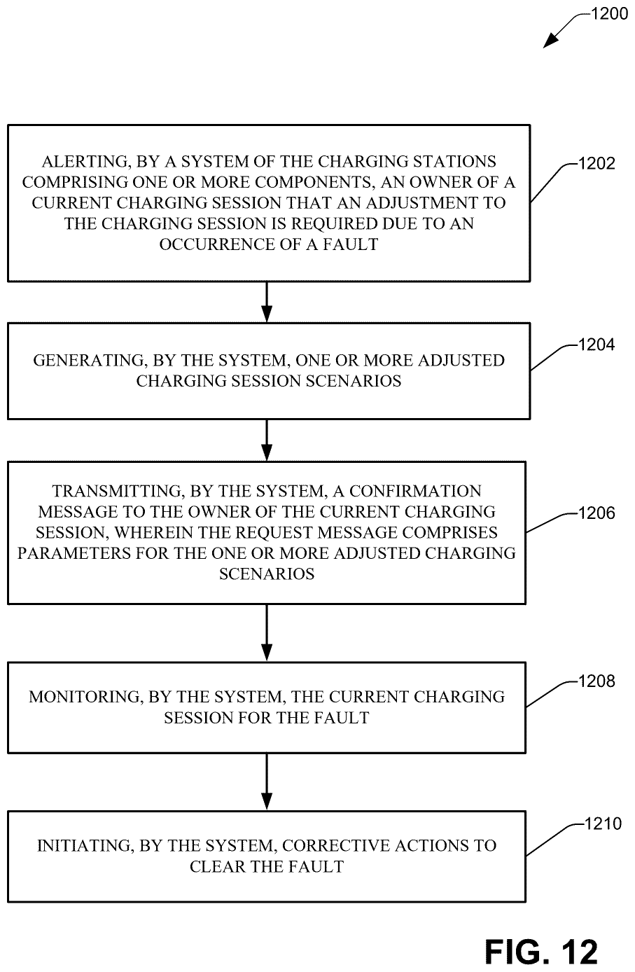

FIG. 12 illustrates a block flow diagram of another example, non-limiting computer-implemented method 1200 for facilitate addressing a fault condition, in accordance with one or more embodiments described herein. As an example, method 1200 can be executed by an electronic computer unit of charging station or a vehicle. Method 1200 comprises, at 1202, alerting, by a system of the charging stations comprising one or more components (e.g., the notification component), an owner of a current charging session that an adjustment to the charging session is required due to an occurrence of a fault. At 1204, the method comprises generating, by the system (e.g., the dynamic schedule adjustment component), one or more adjusted charging session scenarios. At 1206, the method comprises transmitting, by the system (e.g., the communication component component), a confirmation message to the owner of the current charging session, wherein the request message comprises parameters for the one or more adjusted charging scenarios. At 1208, the method comprises monitoring, by the system (e.g., the fault detection component), the current charging session for the fault. At 1210, the method comprises initiating, by the system (e.g., the fault resolution component), corrective actions to clear the fault.

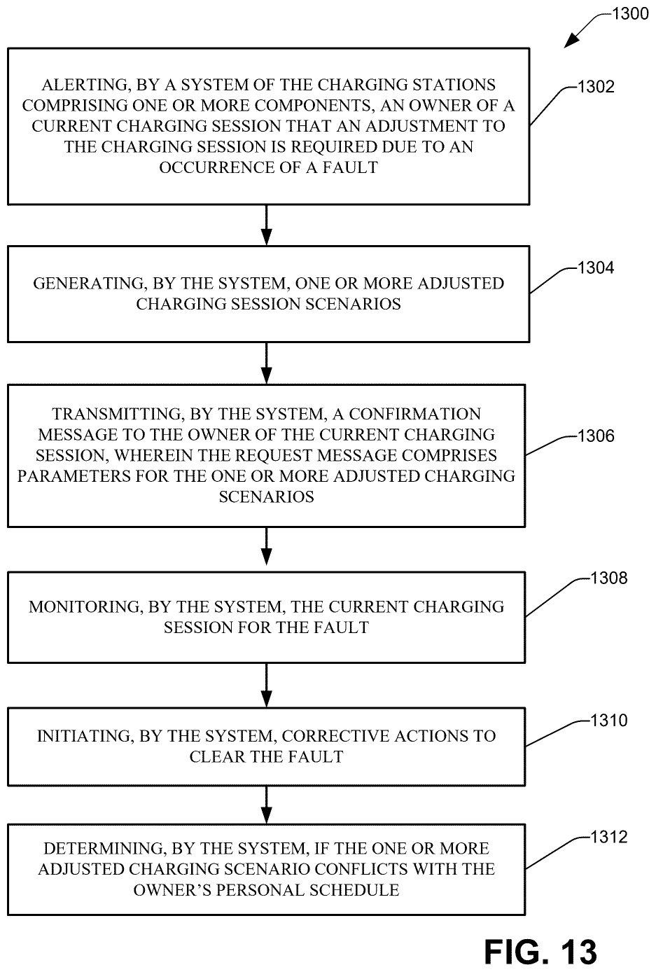

FIG. 13 illustrates a block flow diagram of another example, non-limiting computer-implemented method 1300 for facilitate addressing a fault condition, in accordance with one or more embodiments described herein. As an example, method 1300 can be executed by an electronic computer unit of charging station or a vehicle. Method 1300 comprises, at 1302, alerting, by a system of the charging stations comprising one or more components (e.g., the notification component), an owner of a current charging session that an adjustment to the charging session is required due to an occurrence of a fault. At 1304, the method comprises generating, by the system (e.g., the dynamic schedule adjustment component), one or more adjusted charging session scenarios. At 1306, the method comprises transmitting, by the system (e.g., the communication component component), a confirmation message to the owner of the current charging session, wherein the request message comprises parameters for the one or more adjusted charging scenarios. At 1308, the method comprises monitoring, by the system (e.g., the fault detection component), the current charging session for the fault. At 1310, the method comprises initiating, by the system (e.g., the fault resolution component), corrective actions to clear the fault. At 1312, the method comprises determining, by the system (e.g., a schedule conflict resolution component), if the one or more adjusted charging scenario conflicts with the owner's personal schedule.

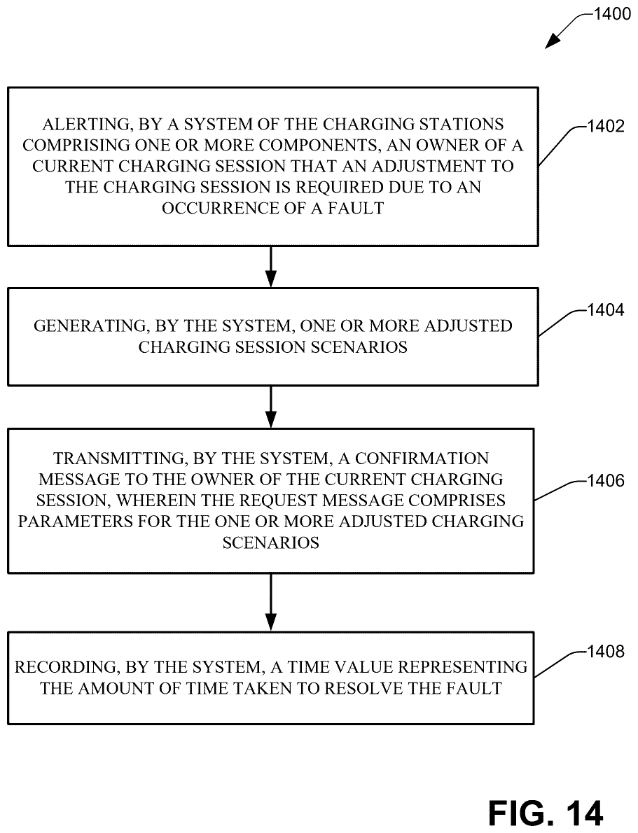

FIG. 14 illustrates a block flow diagram of another example, non-limiting computer-implemented method 1400 for facilitate addressing a fault condition, in accordance with one or more embodiments described herein. As an example, method 1400 can be executed by an electronic computer unit of charging station or a vehicle. Method 1400 comprises, at 1402, alerting, by a system of the charging stations comprising one or more components (e.g., the notification component), an owner of a current charging session that an adjustment to the charging session is required due to an occurrence of a fault. At 1404, the method comprises generating, by the system (e.g., the dynamic schedule adjustment component), one or more adjusted charging session scenarios. At 1406, the method comprises transmitting, by the system (e.g., the communication component component), a confirmation message to the owner of the current charging session, wherein the request message comprises parameters for the one or more adjusted charging scenarios. At 1408, the method comprises recording, by the system (e.g., the time tracking component), a time value representing the amount of time taken to resolve the fault.

### Example Operating Environment and Scenarios

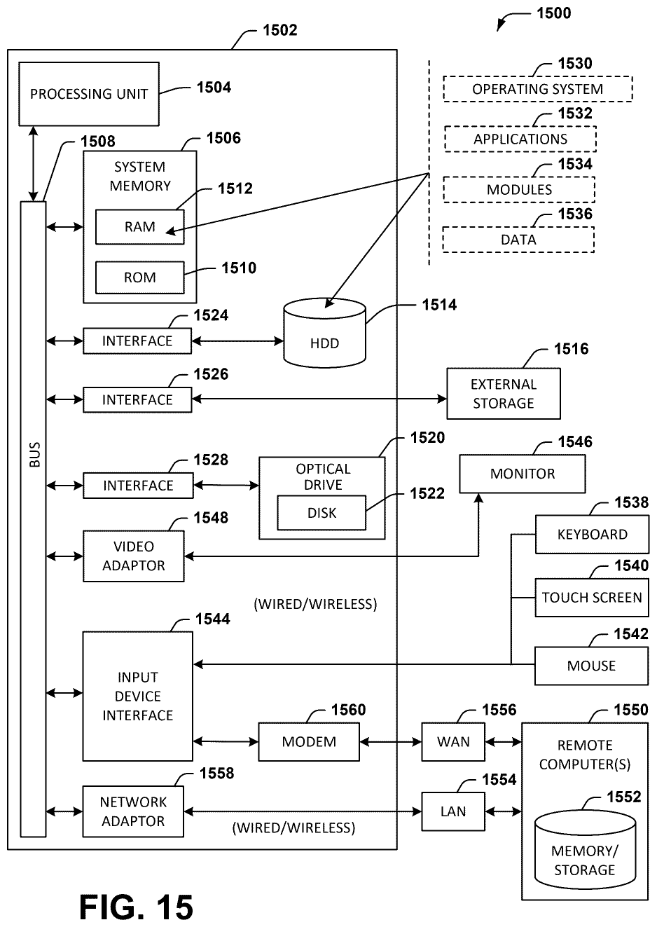

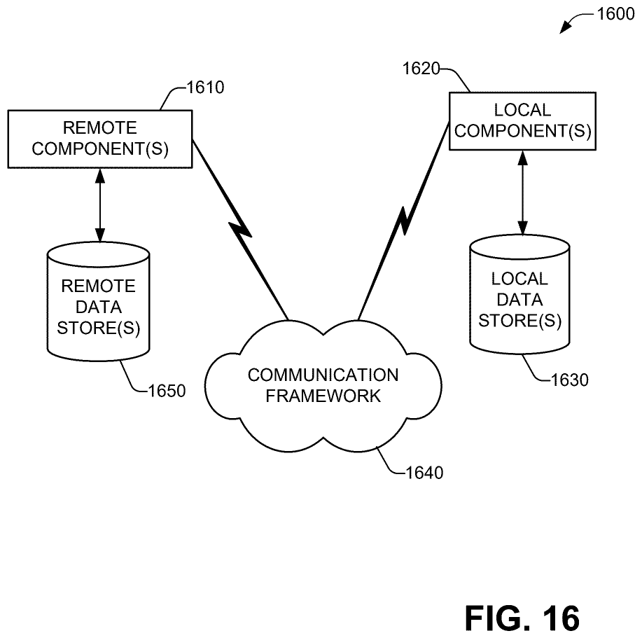

Turning next to FIGS. 15 and 16, a detailed description is provided of additional context for the one or more embodiments described herein.

In order to provide additional context for various embodiments described herein, FIG. 15 and the following discussion are intended to provide a brief, general description of a suitable computing environment 1500 in which the various embodiments described herein can be implemented. While the embodiments have been described above in the general context of computer-executable instructions that can run on one or more computers, those skilled in the art will recognize that the embodiments can be also implemented in combination with other program modules and/or as a combination of hardware and software.

Generally, program modules include routines, programs, components, data structures, etc., that perform particular tasks or implement particular abstract data types. Moreover, those skilled in the art will appreciate that the methods can be practiced with other computer system configurations, including single-processor or multiprocessor computer systems, minicomputers, mainframe computers, IoT devices, distributed computing systems, as well as personal computers, hand-held computing devices, microprocessor-based or programmable consumer electronics, and the like, each of which can be operatively coupled to one or more associated devices.

The embodiments illustrated herein can also be practiced in distributed computing environments where certain tasks are performed by remote processing devices that are linked through a communications network. In a distributed computing environment, program modules can be located in both local and remote memory storage devices.

Computing devices typically include a variety of media, which can include computer-readable storage media, machine-readable storage media, and/or communications media, which two terms are used herein differently from one another as follows. Computer-readable storage media or machine-readable storage media can be any available storage media that can be accessed by the computer and includes both volatile and nonvolatile media, removable and non-removable media. By way of example, and not limitation, computer-readable storage media or machine-readable storage media can be implemented in connection with any method or technology for storage of information such as computer-readable or machine-readable instructions, program modules, structured data, or unstructured data.

Computer-readable storage media can include, but are not limited to, random access memory (RAM), read only memory (ROM), electrically erasable programmable read only memory (EEPROM), flash memory or other memory technology, compact disk read only memory (CD-ROM), digital versatile disk (DVD), Blu-ray disc (BD) or other optical disk storage, magnetic cassettes, magnetic tape, magnetic disk storage or other magnetic storage devices, solid state drives or other solid state storage devices, or other tangible and/or non-transitory media which can be used to store desired information. In this regard, the terms “tangible” or “non-transitory” herein as applied to storage, memory, or computer-readable media, are to be understood to exclude only propagating transitory signals per se as modifiers and do not relinquish rights to all standard storage, memory or computer-readable media that are not only propagating transitory signals per se.

Computer-readable storage media can be accessed by one or more local or remote computing devices, e.g., via access requests, queries, or other data retrieval protocols, for a variety of operations with respect to the information stored by the medium.

Communications media typically embody computer-readable instructions, data structures, program modules or other structured or unstructured data in a data signal such as a modulated data signal, e.g., a carrier wave or other transport mechanism, and includes any information delivery or transport media. The term “modulated data signal” or signals refers to a signal that has one or more of its characteristics set or changed in such a manner as to encode information in one or more signals. By way of example, and not limitation, communication media include wired media, such as a wired network or direct-wired connection, and wireless media such as acoustic, RF, infra-red and other wireless media.

It is to be understood that when an element is referred to as being “coupled” to another element, it can describe one or more different types of coupling including, but not limited to, chemical coupling, communicative coupling, electrical coupling, electromagnetic coupling, operative coupling, optical coupling, physical coupling, thermal coupling, and/or another type of coupling. Likewise, it is to be understood that when an element is referred to as being “connected” to another element, it can describe one or more different types of connecting including, but not limited to, electrical connecting, electromagnetic connecting, operative connecting, optical connecting, physical connecting, thermal connecting, and/or another type of connecting.

With reference again to FIG. 15, the example environment 1500 for implementing various embodiments of the aspects described herein includes a computer 1502, the computer 1502 including a processing unit 1504, a system memory 1506 and a system bus 1508. The system bus 1508 couples system components including, but not limited to, the system memory 1506 to the processing unit 1504. The processing unit 1504 can be any of various commercially available processors and may include a cache memory. Dual microprocessors and other multi-processor architectures can also be employed as the processing unit 1504.

The system bus 1508 can be any of several types of bus structure that can further interconnect to a memory bus (with or without a memory controller), a peripheral bus, and a local bus using any of a variety of commercially available bus architectures. The system memory 1506 includes ROM 1510 and RAM 1512. A basic input/output system (BIOS) can be stored in a non-volatile memory such as ROM, erasable programmable read only memory (EPROM), EEPROM, which BIOS contains the basic routines that help to transfer information between elements within the computer 1502, such as during startup. The RAM 1512 can also include a high-speed RAM such as static RAM for caching data.

The computer 1502 further includes an internal hard disk drive (HDD) 1514 (e.g., EIDE, SATA), one or more external storage devices 1516 (e.g., a magnetic floppy disk drive (FDD) 1516, a memory stick or flash drive reader, a memory card reader, etc.) and an optical disk drive 1520 and 1022 (e.g., which can read or write from a CD-ROM disc, a DVD, a BD, etc.). While the internal HDD 1514 is illustrated as located within the computer 1502, the internal HDD 1514 can also be configured for external use in a suitable chassis (not shown). Additionally, while not shown in environment 1500, a solid-state drive (SSD) could be used in addition to, or in place of, an HDD 1514. The HDD 1514, external storage device(s) 1516 and optical disk drive 1520 can be connected to the system bus 1508 by an HDD interface 1524, an external storage interface 1526 and an optical drive interface 1528, respectively. The interface 1524 for external drive implementations can include at least one or both Universal Serial Bus (USB) and Institute of Electrical and Electronics Engineers (IEEE) 1394 interface technologies. Other external drive connection technologies are within contemplation of the embodiments described herein.

The drives and their associated computer-readable storage media provide nonvolatile storage of data, data structures, computer-executable instructions, and so forth. For the computer 1502, the drives and storage media accommodate the storage of any data in a suitable digital format. Although the description of computer-readable storage media above refers to respective types of storage devices, it should be appreciated by those skilled in the art that other types of storage media which are readable by a computer, whether presently existing or developed in the future, could also be used in the example operating environment, and further, that any such storage media can contain computer-executable instructions for performing the methods described herein.

A number of program modules can be stored in the drives and RAM 1512, including an operating system 1530, one or more application programs 1532, other program modules 1534 and program data 1536. All or portions of the operating system, applications, modules, and/or data can also be cached in the RAM 1512. The systems and methods described herein can be implemented utilizing various commercially available operating systems or combinations of operating systems.

Computer 1502 can optionally comprise emulation technologies. For example, a hypervisor (not shown) or other intermediary can emulate a hardware environment for operating system 1530, and the emulated hardware can optionally be different from the hardware illustrated in FIG. 15. In such an embodiment, operating system 1530 can comprise one virtual machine (VM) of multiple VMs hosted at computer 1502. Furthermore, operating system 1530 can provide runtime environments, such as the Java runtime environment or the .NET framework, for applications 1532. Runtime environments are consistent execution environments that allow applications 1532 to run on any operating system that includes the runtime environment. Similarly, operating system 1530 can support containers, and applications 1532 can be in the form of containers, which are lightweight, standalone, executable packages of software that include, e.g., code, runtime, system tools, system libraries and settings for an application.

Further, computer 1502 can comprise a security module, such as a trusted processing module (TPM). For instance, with a TPM, boot components hash next in time boot components and wait for a match of results to secured values, before loading a next boot component. This process can take place at any layer in the code execution stack of computer 1502, e.g., applied at the application execution level or at the operating system (OS) kernel level, thereby enabling security at any level of code execution.

A user can enter commands and information into the computer 1502 through one or more wired/wireless input devices, e.g., a keyboard 1538, a touch screen 1540, and a pointing device, such as a mouse 1542. Other input devices (not shown) can include a microphone, an infra-red (IR) remote control, a radio frequency (RF) remote control, or other remote control, a joystick, a virtual reality controller and/or virtual reality headset, a game pad, a stylus pen, an image input device, e.g., camera(s), a gesture sensor input device, a vision movement sensor input device, an emotion or facial detection device, a biometric input device, e.g., fingerprint or iris scanner, or the like. These and other input devices are often connected to the processing unit 1504 through an input device interface 1544 that can be coupled to the system bus 1508, but can be connected by other interfaces, such as a parallel port, an IEEE 1394 serial port, a game port, a USB port, an IR interface, a BLUETOOTH® interface, etc.

A monitor 1546 or other type of display device can also be connected to the system bus 1508 via an interface, such as a video adapter 1548. In addition to the monitor 1546, a computer typically includes other peripheral output devices (not shown), such as speakers, printers, etc.

The computer 1502 can operate in a networked environment using logical connections via wired and/or wireless communications to one or more remote computers, such as a remote computer(s) 1550. The remote computer(s) 1550 can be a workstation, a server computer, a router, a personal computer, portable computer, microprocessor-based entertainment appliance, a peer device or other common network node, and typically includes many or all of the elements described relative to the computer 1502, although, for purposes of brevity, only a memory/storage device 1552 is illustrated. The logical connections depicted include wired/wireless connectivity to a local area network (LAN) 1554 and/or larger networks, e.g., a wide area network (WAN) 1556. Such LAN and WAN networking environments are commonplace in offices and companies, and facilitate enterprise-wide computer networks, such as intranets, all of which can connect to a global communications network, e.g., the internet.

When used in a LAN networking environment, the computer 1502 can be connected to the local network 1554 through a wired and/or wireless communication network interface or adapter 1558. The adapter 1558 can facilitate wired or wireless communication to the LAN 1554, which can also include a wireless access point (AP) disposed thereon for communicating with the adapter 1558 in a wireless mode.

When used in a WAN networking environment, the computer 1502 can include a modem 1560 or can be connected to a communications server on the WAN 1556 via other means for establishing communications over the WAN 1556, such as by way of the internet. The modem 1560, which can be internal or external and a wired or wireless device, can be connected to the system bus 1508 via the input device interface 1544. In a networked environment, program modules depicted relative to the computer 1502 or portions thereof, can be stored in the remote memory/storage device 1552. It will be appreciated that the network connections shown are examples and other means of establishing a communications link between the computers can be used.

When used in either a LAN or WAN networking environment, the computer 1502 can access cloud storage systems or other network-based storage systems in addition to, or in place of, external storage devices 1516 as described above. Generally, a connection between the computer 1502 and a cloud storage system can be established over a LAN 1554 or WAN 1556 e.g., by the adapter 1558 or modem 1560, respectively. Upon connecting the computer 1502 to an associated cloud storage system, the external storage interface 1526 can, with the aid of the adapter 1558 and/or modem 1560, manage storage provided by the cloud storage system as it would other types of external storage. For instance, the external storage interface 1526 can be configured to provide access to cloud storage sources as if those sources were physically connected to the computer 1502.

The computer 1502 can be operable to communicate with any wireless devices or entities operatively disposed in wireless communication, e.g., a printer, scanner, desktop and/or portable computer, portable data assistant, communications satellite, any piece of equipment or location associated with a wirelessly detectable tag (e.g., a kiosk, news stand, store shelf, etc.), and telephone. This can include Wireless Fidelity (Wi-Fi) and BLUETOOTH® wireless technologies. Thus, the communication can be a predefined structure as with a conventional network or simply an ad hoc communication between at least two devices.

The above description includes non-limiting examples of the various embodiments. It is, of course, not possible to describe every conceivable combination of components or methodologies for purposes of describing the disclosed subject matter, and one skilled in the art may recognize that further combinations and permutations of the various embodiments are possible. The disclosed subject matter is intended to embrace all such alterations, modifications, and variations that fall within the spirit and scope of the appended claims.

Referring now to details of one or more elements illustrated in FIG. 16, an illustrative cloud computing environment 1600 is depicted. FIG. 16 is a schematic block diagram of a computing environment 1600 with which the disclosed subject matter can interact. The system 1600 comprises one or more remote component(s) 1610. The remote component(s) 1610 can be hardware and/or software (e.g., threads, processes, computing devices). In some embodiments, remote component(s) 1610 can be a distributed computer system, connected to a local automatic scaling component and/or programs that use the resources of a distributed computer system, via communication framework 1640. Communication framework 1640 can comprise wired network devices, wireless network devices, mobile devices, wearable devices, radio access network devices, gateway devices, femtocell devices, servers, etc.

The system 1600 also comprises one or more local component(s) 1620. The local component(s) 1620 can be hardware and/or software (e.g., threads, processes, computing devices). In some embodiments, local component(s) 1620 can comprise an automatic scaling component and/or programs that communicate/use the remote resources 1610 and 1620, etc., connected to a remotely located distributed computing system via communication framework 1640.

One possible communication between a remote component(s) 1610 and a local component(s) 1620 can be in the form of a data packet adapted to be transmitted between two or more computer processes. Another possible communication between a remote component(s) 1610 and a local component(s) 1620 can be in the form of circuit-switched data adapted to be transmitted between two or more computer processes in radio time slots. The system 1600 comprises a communication framework 1640 that can be employed to facilitate communications between the remote component(s) 1610 and the local component(s) 1620, and can comprise an air interface, e.g., Uu interface of a UMTS network, via a long-term evolution (LTE) network, etc. Remote component(s) 1610 can be operably connected to one or more remote data store(s) 1650, such as a hard drive, solid state drive, SIM card, device memory, etc., that can be employed to store information on the remote component(s) 1610 side of communication framework 1640. Similarly, local component(s) 1620 can be operably connected to one or more local data store(s) 1630, that can be employed to store information on the local component(s) 1620 side of communication framework 1640.

With regard to the various functions performed by the above described components, devices, circuits, systems, etc., the terms (including a reference to a “means”) used to describe such components are intended to also include, unless otherwise indicated, any structure(s) which performs the specified function of the described component (e.g., a functional equivalent), even if not structurally equivalent to the disclosed structure. In addition, while a particular feature of the disclosed subject matter may have been disclosed with respect to only one of several implementations, such feature may be combined with one or more other features of the other implementations as may be desired and advantageous for any given or particular application.

The terms “exemplary” and/or “demonstrative” as used herein are intended to mean serving as an example, instance, or illustration. For the avoidance of doubt, the subject matter disclosed herein is not limited by such examples. In addition, any aspect or design described herein as “exemplary” and/or “demonstrative” is not necessarily to be construed as preferred or advantageous over other aspects or designs, nor is it meant to preclude equivalent structures and techniques known to one skilled in the art. Furthermore, to the extent that the terms “includes,” “has,” “contains,” and other similar words are used in either the detailed description or the claims, such terms are intended to be inclusive-in a manner similar to the term “comprising” as an open transition word-without precluding any additional or other elements.

The term “or” as used herein is intended to mean an inclusive “or” rather than an exclusive “or.” For example, the phrase “A or B” is intended to include instances of A, B, and both A and B. Additionally, the articles “a” and “an” as used in this application and the appended claims should generally be construed to mean “one or more” unless either otherwise specified or clear from the context to be directed to a singular form.

The term “set” as employed herein excludes the empty set, i.e., the set with no elements therein. Thus, a “set” in the subject disclosure includes one or more elements or entities. Likewise, the term “group” as utilized herein refers to a collection of one or more entities.

The terms “first,” “second,” “third,” and so forth, as used in the claims, unless otherwise clear by context, is for clarity only and does not otherwise indicate or imply any order in time. For instance, “a first determination,” “a second determination,” and “a third determination,” does not indicate or imply that the first determination is to be made before the second determination, or vice versa, etc.

As used in this disclosure, in some embodiments, the terms “component,” “system” and the like are intended to refer to, or comprise, a computer-related entity or an entity related to an operational apparatus with one or more specific functionalities, wherein the entity can be either hardware, a combination of hardware and software, software, or software in execution. As an example, a component can be, but is not limited to being, a process running on a processor, a processor, an object, an executable, a thread of execution, computer-executable instructions, a program, and/or a computer. By way of illustration and not limitation, both an application running on a server and the server can be a component.

One or more components can reside within a process and/or thread of execution and a component can be localized on one computer and/or distributed between two or more computers. In addition, these components can execute from various computer readable media having various data structures stored thereon. The components can communicate via local and/or remote processes such as in accordance with a signal having one or more data packets (e.g., data from one component interacting with another component in a local system, distributed system, and/or across a network such as the internet with other systems via the signal). As another example, a component can be an apparatus with specific functionality provided by mechanical parts operated by electric or electronic circuitry, which is operated by a software application or firmware application executed by a processor, wherein the processor can be internal or external to the apparatus and executes at least a part of the software or firmware application. As yet another example, a component can be an apparatus that provides specific functionality through electronic components without mechanical parts, the electronic components can comprise a processor therein to execute software or firmware that confers at least in part the functionality of the electronic components. While various components have been illustrated as separate components, it will be appreciated that multiple components can be implemented as a single component, or a single component can be implemented as multiple components, without departing from example embodiments.

The term “facilitates” as used herein is in the context of a system, device or component “facilitating” one or more actions or operations, in respect of the nature of complex computing environments in which multiple components and/or multiple devices can be involved in some computing operations. Non-limiting examples of actions that may or may not involve multiple components and/or multiple devices comprise transmitting or receiving data, establishing a connection between devices, determining intermediate results toward obtaining a result, etc. In this regard, a computing device or component can facilitate an operation by playing any part in accomplishing the operation. When operations of a component are described herein, it is thus to be understood that where the operations are described as facilitated by the component, the operations can be optionally completed with the cooperation of one or more other computing devices or components, such as, but not limited to, sensors, antennae, audio and/or visual output devices, other devices, etc.

Further, the various embodiments can be implemented as a method, apparatus or article of manufacture using standard programming and/or engineering techniques to produce software, firmware, hardware, or any combination thereof to control a computer to implement the disclosed subject matter. The term “article of manufacture” as used herein is intended to encompass a computer program accessible from any computer-readable (or machine-readable) device or computer-readable (or machine-readable) storage/communications media. For example, computer readable storage media can comprise, but are not limited to, magnetic storage devices (e.g., hard disk, floppy disk, magnetic strips), optical disks (e.g., compact disk (CD), digital versatile disk (DVD)), smart cards, and flash memory devices (e.g., card, stick, key drive). Of course, those skilled in the art will recognize many modifications can be made to this configuration without departing from the scope or spirit of the various embodiments.

Moreover, terms such as “mobile device equipment,” “mobile station,” “mobile,” “subscriber station,” “access terminal,” “terminal,” “handset,” “communication device,” “mobile device” (and/or terms representing similar terminology) can refer to a wireless device utilized by a subscriber or mobile device of a wireless communication service to receive or convey data, control, voice, video, sound, gaming or substantially any data-stream or signaling-stream. The foregoing terms are utilized interchangeably herein and with reference to the related drawings. Likewise, the terms “access point (AP),” “Base Station (BS),” “BS transceiver,” “BS device,” “cell site,” “cell site device,” “gNode B (gNB),” “evolved Node B (eNode B, eNB),” “home Node B (HNB)” and the like, refer to wireless network components or appliances that transmit and/or receive data, control, voice, video, sound, gaming or substantially any data-stream or signaling-stream from one or more subscriber stations. Data and signaling streams can be packetized or frame-based flows.

Furthermore, the terms “device,” “communication device,” “mobile device,” “subscriber,” “client entity,” “consumer,” “client entity,” “entity” and the like are employed interchangeably throughout, unless context warrants particular distinctions among the terms. It should be appreciated that such terms can refer to human entities or automated components supported through artificial intelligence (e.g., a capacity to make inference based on complex mathematical formalisms), which can provide simulated vision, sound recognition and so forth.

It should be noted that although various aspects and embodiments are described herein in the context of 5G or other next generation networks, the disclosed aspects are not limited to a 5G implementation and can be applied in other network next generation implementations, such as sixth generation (6G), or other wireless systems. In this regard, aspects or features of the disclosed embodiments can be exploited substantially in any wireless communication technology. Such wireless communication technologies can include universal mobile telecommunications system (UMTS), global system for mobile communication (GSM), code division multiple access (CDMA), wideband CDMA (WCMDA), CDMA2000, time division multiple access (TDMA), frequency division multiple access (FDMA), multi-carrier CDMA (MC-CDMA), single-carrier CDMA (SC-CDMA), single-carrier FDMA (SC-FDMA), orthogonal frequency division multiplexing (OFDM), discrete Fourier transform spread OFDM (DFT-spread OFDM), filter bank based multi-carrier (FBMC), zero tail DFT-spread-OFDM (ZT DFT-s-OFDM), generalized frequency division multiplexing (GFDM), fixed mobile convergence (FMC), universal fixed mobile convergence (UFMC), unique word OFDM (UW-OFDM), unique word DFT-spread OFDM (UW DFT-Spread-OFDM), cyclic prefix OFDM (CP-OFDM), resource-block-filtered OFDM, wireless fidelity (Wi-Fi), worldwide interoperability for microwave access (WiMAX), wireless local area network (WLAN), general packet radio service (GPRS), enhanced GPRS, third generation partnership project (3GPP), long term evolution (LTE), 5G, third generation partnership project 2 (3GPP2), ultra-mobile broadband (UMB), high speed packet access (HSPA), evolved high speed packet access (HSPA+), high-speed downlink packet access (HSDPA), high-speed uplink packet access (HSUPA), Zigbee, or another institute of electrical and electronics engineers (IEEE) 802.12 technology.

The description of illustrated embodiments of the subject disclosure as provided herein, including what is described in the Abstract, is not intended to be exhaustive or to limit the disclosed embodiments to the precise forms disclosed. While specific embodiments and examples are described herein for illustrative purposes, various modifications are possible that are considered within the scope of such embodiments and examples, as one skilled in the art can recognize. In this regard, while the subject matter has been described herein in connection with various embodiments and corresponding drawings, where applicable, it is to be understood that other similar embodiments can be used or modifications and additions can be made to the described embodiments for performing the same, similar, alternative, or substitute function of the disclosed subject matter without deviating therefrom. Therefore, the disclosed subject matter should not be limited to any single embodiment described herein, but rather should be construed in breadth and scope in accordance with the appended claims below.

Various non-limiting aspects of various embodiments described herein are presented in the following clauses.

Clause 1. A system, comprising: a memory that stores computer executable components; and a processor that executes the computer executable components stored in the memory, wherein the computer executable components comprise: a notification component notifies an owner of a current charging session that an adjustment to the charging session is required due to an occurrence of a fault; a dynamic schedule adjustment component generates one or more adjusted charging session scenarios; and a communication component that transmits a confirmation message to the owner of the current charging session, wherein the request message comprises parameters for one or more adjusted charging scenarios.

Clause 2. The system of any one or more preceding clause(s), further comprising: a fault detection component that monitors the current charging session for the fault and determines a fault type; and a fault resolution component that initiates correction actions to clear the fault.

Clause 3. The system of any one or more preceding clause(s), further comprising: a time tracking component records a time value representing amount of time taken to resolve the fault.

Clause 4. The system of any one or more preceding clause(s), wherein the one or more adjusted charging session scenarios comprises a first adjusted charging scenario maintains the end of the current charging session.

Clause 5. The system of any one or more preceding clause(s), wherein the one or more adjusted charging session scenarios comprises a second adjusted charging scenario extends the current charging session by adding the time value.

Clause 6. The system of any one or more preceding clause(s), wherein the one or more adjusted charging session scenarios comprises a third adjusted charging scenario maintains the end of current charging session and increasing charging speed.

Clause 7. The system of any one or more preceding clause(s), further comprising: a schedule conflict resolution component determines if the one or more adjusted charging scenario conflicts with the owner's personal schedule.

Clause 8. The system of any one or more preceding clause(s), wherein dynamic schedule adjustment component determines if the current charging session was impacted by the occurrence of the fault based on the time value.

Clause 9. The system of any one or more preceding clause(s) wherein the communication component receives a response message comprising desired parameters for a selected charging scenario.

Clause 10. The system of any one or more preceding clause(s), wherein the communication component that transmits, in response to receiving the response message, a subsequent request message to subsequent owner of a subsequent charging session, wherein the request message comprises parameters for the one or more adjusted charging scenarios.

Clause 11. A method for controlling an enclosure of a vehicle, comprising: alerting, by a system of the charging stations comprising one or more components, an owner of a current charging session that an adjustment to the charging session is required due to an occurrence of a fault; generating, by the system, one or more adjusted charging session scenarios; and transmitting, by the system, a confirmation message to the owner of the current charging session, wherein the request message comprises parameters for the one or more adjusted charging scenarios.

Clause 12. The method of any one or more preceding clause(s), further comprising: monitoring, by the system, the current charging session for the fault; and initiating, by the system, corrective actions to clear the fault.

Clause 13. The method of any one or more preceding clause(s), further comprising: determining, by the system, if the one or more adjusted charging scenario conflicts with the owner's personal schedule.

Clause 14. The method of any one or more preceding clause(s), further comprising: recording, by the system, a time value representing the amount of time taken to resolve the fault.

Clause 15. The method of any one or more preceding clause(s), wherein the one or more adjusted charging session scenarios comprises a first adjusted charging scenario maintains the end of the current charging session.

Clause 16. The method of any one or more preceding clause(s), wherein the one or more adjusted charging session scenarios comprises a second adjusted charging scenario extends the current charging session by adding the time value.

Clause 17. The method of any one or more preceding clause(s), wherein the one or more adjusted charging session scenarios comprises a third adjusted charging scenario maintains the end of current charging session and increasing charging speed.

Clause 18. A non-transitory machine-readable medium, comprising executable instructions that, when executed by a processor, facilitate performance of operations, comprising: alerting an owner of a current charging session that an adjustment to the charging session is required due to an occurrence of a fault; generating one or more adjusted charging session scenarios; and transmitting a confirmation message to the owner of the current charging session, wherein the request message comprises parameters for the one or more adjusted charging scenarios.

Clause 19. The non-transitory machine-readable medium of any one or more preceding clause(s), further comprising: monitoring the current charging session for the fault; initiating corrective actions to clear the fault; and recording a time value representing the amount of time taken to resolve the fault.

Clause 20. The non-transitory machine-readable medium of any one or more preceding clause(s), further comprising: receiving a response message comprising desired parameters for a selected charging scenario; and transmitting, in response to receiving the response message, a subsequent request message to subsequent owner of a subsequent charging session, wherein the request message comprises parameters for the one or more adjusted charging scenarios.

Clause 21. Any suitable combination of clauses 1-10.

Clause 22. Any suitable combination of clauses 11-17.

Clause 23. Any suitable combination of clauses 18-20.

What is claimed is:

1. A system, comprising:
a memory that stores computer executable components; and
a processor that executes the computer executable components stored in the memory, wherein the computer executable components comprise:
a notification component notifies an owner of a current charging session that an adjustment to the charging session is required due to an occurrence of a fault;
a dynamic schedule adjustment component generates one or more adjusted charging session scenarios; and
a communication component that transmits a confirmation message to the owner of the current charging session, wherein the request message comprises parameters for one or more adjusted charging scenarios.

2. The system of claim 1, further comprising:
a fault detection component that monitors the current charging session for the fault and determines a fault type; and
a fault resolution component that initiates correction actions to clear the fault.

3. The system of claim 2, further comprising:
a time tracking component records a time value representing amount of time taken to resolve the fault.

4. The system of claim 1, wherein the one or more adjusted charging session scenarios comprises a first adjusted charging scenario maintains the end of the current charging session.

5. The system of claim 1, wherein the one or more adjusted charging session scenarios comprises a second adjusted charging scenario extends the current charging session by adding the time value.

6. The system of claim 1, wherein the one or more adjusted charging session scenarios comprises a third adjusted charging scenario maintains the end of current charging session and increasing charging speed.

7. The system of claim 4, further comprising:
a schedule conflict resolution component determines if the one or more adjusted charging scenario conflicts with the owner's personal schedule.

8. The system of claim 1, wherein dynamic schedule adjustment component determines if the current charging session was impacted by the occurrence of the fault based on the time value.

9. The system of claim 1, wherein the communication component receives a response message comprising desired parameters for a selected charging scenario.

10. The system of claim 9, wherein the communication component that transmits, in response to receiving the response message, a subsequent request message to subsequent owner of a subsequent charging session, wherein the request message comprises parameters for the one or more adjusted charging scenarios.

11. A method for controlling an enclosure of a vehicle, comprising:
alerting, by a system of the charging stations comprising one or more components, an owner of a current charging session that an adjustment to the charging session is required due to an occurrence of a fault;
generating, by the system, one or more adjusted charging session scenarios; and
transmitting, by the system, a confirmation message to the owner of the current charging session, wherein the request message comprises parameters for the one or more adjusted charging scenarios.

12. The method of claim 11, further comprising:
monitoring, by the system, the current charging session for the fault; and
initiating, by the system, corrective actions to clear the fault.

13. The method of claim 12, further comprising:
determining, by the system, if the one or more adjusted charging scenario conflicts with the owner's personal schedule.

14. The method of claim 11, further comprising:
recording, by the system, a time value representing the amount of time taken to resolve the fault.

15. The method of claim 11, wherein the one or more adjusted charging session scenarios comprises a first adjusted charging scenario maintains the end of the current charging session.

16. The method of claim 11, wherein the one or more adjusted charging session scenarios comprises a second adjusted charging scenario extends the current charging session by adding the time value.

17. The method of claim 11, wherein the one or more adjusted charging session scenarios comprises a third adjusted charging scenario maintains the end of current charging session and increasing charging speed.

18. A non-transitory machine-readable medium, comprising executable instructions that, when executed by a processor, facilitate performance of operations, comprising:
alerting an owner of a current charging session that an adjustment to the charging session is required due to an occurrence of a fault;
generating one or more adjusted charging session scenarios; and
transmitting a confirmation message to the owner of the current charging session, wherein the request message comprises parameters for the one or more adjusted charging scenarios.

19. The non-transitory machine-readable medium of claim 18, further comprising:
monitoring the current charging session for the fault;
initiating corrective actions to clear the fault; and
recording a time value representing the amount of time taken to resolve the fault.

20. The non-transitory machine-readable medium of claim 18, further comprising:
receiving a response message comprising desired parameters for a selected charging scenario; and
transmitting, in response to receiving the response message, a subsequent request message to subsequent owner of a subsequent charging session, wherein the request message comprises parameters for the one or more adjusted charging scenarios.
